(19) United States
(12) Patent Application Publication
(10) Pub. No.: US 2021/0318738 A1
(43) Pub. Date: Oct. 14, 2021

(54) METHODS AND APPARATUS FOR ENHANCED POWER DELIVERY BETWEEN DEVICES

(71) Applicant: Apple Inc., Cupertino, CA (US)

(72) Inventors: Scott A. JACKSON, Gilroy, CA (US); Alexei E. KOSUT, Campbell, CA (US); William O. FERRY, San Jose, CA (US); Reese A. SCHREIBER, San Jose, CA (US); Breton M. SAUNDERS, Los Gatos, CA (US); Corey LANGE, Cupertino, CA (US); David G. CONROY, El Granada, CA (US); Srivatsav VENKATESAN, Cupertino, CA (US); Steven P. HIER, Morgan Hill, CA (US); Carlos M. CALDERON, San Jose, CA (US)

(73) Assignee: Apple Inc., Cupertino, CA (US)

(21) Appl. No.: 17/229,553

(22) Filed: Apr. 13, 2021

Related U.S. Application Data
(60) Provisional application No. 63/009,283, filed on Apr. 13, 2020.

(51) Int. Cl. G06F 1/26; G06F 13/42

(52) U.S. Cl. CPC G06F 1/266; G06F 2213/0042; G06F 13/4282

(57) ABSTRACT

Methods and apparatus for enhanced power delivery between devices. In one embodiment, the power delivery is enhanced relative to legacy capabilities, and a source device negotiates with a sink device to establish a high-voltage (HV) power contract. In one variant, such HV operation enables power delivery greater than the legacy USB-C standard maximum of 20 V and 100 W. In one implementation, the source, sink, and/or source and sink collectively ensure that multiple criteria relating to power delivery are met for the interface (i.e., source, the sink, and the interposed cable or power delivery medium). Multiple conditions, including enclosure construction compliance and device capabilities, must be cleared to ensure safety while operating beyond standard maximums. If the criteria are met, HV validation is complete, and the source may offer HV operation to the sink to establish the HV contract. Additional fail-safe mechanisms enable the HV contract to discontinue upon triggering.

### RELATED APPLICATIONS

This application claims the benefit of U.S. Provisional Application No. 63/009,283, filed Apr. 13, 2020, which is incorporated herein by reference in its entirety. This application is also generally related to the subject matter of co-owned U.S. patent application Ser. No. 12/840,194 filed Jul. 20, 2010 and entitled “Methods and Apparatus for Intelligently Providing Power to a Device”, which is incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### 1. Technical Field

The disclosure relates generally to the field of electronic devices, and more specifically in one exemplary aspect to electronic device power management, including inter alia, bus connectors used for such electronic devices, and device voltage and scaling on USB-C Power Delivery (USB PD).

### 2. Description of Related Technology

Modern computer systems, mobile devices, peripheral apparatus, and electronic interfaces utilize standardized mechanisms for data transfer and electrical power delivery. One ubiquitous example of such interfaces and their supporting protocols is USB (Universal Serial Bus) Type-C, an industry-standard connection interface for signaling data and transmitting power on a single physical cable or interface between computerized devices and/or associated external peripherals.

Details and existing solutions regarding USB-C may be found in the “Universal Serial Bus Type-C Cable and Connector Specification” Release 2.0 published August, 2019, which is incorporated herein by reference in its entirety. Many existing USB-C ports implement the USB 3.1 and 3.2 data-transfer standards. The second-generation (Gen 2) version of USB 3.1 is capable of enabling data transfer at up to 10 gigabits per second (Gbps), while USB 3.2 supports rates up to 20 Gbps. Details regarding the USB 3.1 and 3.2 protocols may be found in e.g., “Universal Serial Bus 3.2 Specification” dated Sep. 22, 2017, which is incorporated herein by reference in its entirety.

USB-C supports the USB Power Delivery (USB PD) specification, which allows delivery of up to 100 watts of power between devices. As comparisons, a prior-generation USB 2.0 port may deliver a maximum power of 2.5 watts, the USB 3.0 specification defines a maximum power delivery of 4.5 watts, and USB-C (without PD) may deliver a maximum of 15 watts at 5 volts. Hence, USB PD is capable of substantially more power delivery than other USB standards.

However, as required under current IEC (International Electrotechnical Commission) and other technical standards and safety rules (see inter alia IEC 61508—“Functional safety of electrical/electronic/programmable electronic safety related systems”; IEC 62368-1:2018—“Audio/video, information and communication technology equipment—Part 1: Safety requirements, ” and IEC 62368-3:2017—“Audio/video, information and communication technology equipment Part 3: Safety aspects for DC power transfer through communication cables and ports”, each of the foregoing incorporated herein by reference in its entirety), device interfaces which exceed the aforementioned 100 W of electrical power must meet more stringent requirements in order to ensure electrical safety for users of such devices, and such stringent requirements may be incompatible with space, weight, cost, and/or other design considerations relating to that device.

Currently, host workloads are increasing such that the aforementioned 100 W limitation presents a significant bottleneck in terms of power delivery performance. There is an increasing demand in computational power by virtue of, e.g., increasing number of processor cores, co-processors, display power, peripherals, etc. There is also a continued increase in the use of computationally intensive applications such as professional-grade video or audio editing. Host “power-out” needs are increasing as well. For example, there is an increasing demand for higher power and an increasing number of USB-C output ports (per device, per application, etc.). Available USB-C input power must keep pace with these increasing workload demands, or otherwise significant reduction of user experience (i.e., increased charging times and/or frequency of charging) will occur.

Thus, enhanced solutions are needed for delivering power to existing devices or applications, and those that will be developed in the future, via existing port interfaces (including via potential future expansions or modifications/updates thereto), as well as other as-of-yet unforeseen interfaces which may transfer electrical power from one device to another. Such improved solutions should ideally both support delivery at higher power levels (e.g., above the extant 100 W limitation) and remain compatible with existing and legacy functions of the constituent devices and interfaces (e.g., USB-C and its predecessors in the exemplary context of USB interfaces), while also obeying all relevant regulations and tenets of electrical safety for users of powering (source) and powered (sink) devices.

### SUMMARY

The present disclosure satisfies the foregoing needs by providing, inter alia, methods and apparatus for power provision including e.g., voltage scaling, via a data interface.

In one aspect, an apparatus configured to provide scaled power delivery to another apparatus is disclosed.

In another aspect, a method for enhanced power delivery between electronic devices is disclosed.

In another aspect, a non-transitory computer-readable apparatus is disclosed. In one embodiment, the non-transitory computer-readable apparatus includes a storage medium having a computer program, the computer program comprising a plurality of computer-readable instructions configured to, when executed, cause an apparatus to enable non-standard power delivery.

In another aspect, a cable apparatus configured for high-voltage power deliver is disclosed.

In a further aspect, a host or source device capable of powering one or more sink devices via a wireline interface is disclosed. In one embodiment, the wireline interface includes a USB-C compliant interface, and powering includes provision of voltage levels sufficient to generate over 100 W (J/s), such as via provision of one or more available voltages that exceed 20V.

In one variant, the host device includes logic configured to enable communication via the wireline interface with one or more sink devices, including in support of establishing HV (high voltage) operational states based on a communication protocol between the source and sink.

In yet another aspect, a powered or sink device capable of being powered by one or more source devices via a wireline interface is disclosed. In one embodiment, the wireline interface includes a USB-C compliant interface, and powering includes receipt of voltage levels sufficient to provide over 100 W (J/s), such as via receipt of signals having one or more available voltages that exceed 20V.

In one variant, the sink device includes logic configured to enable communication via the wireline interface with one or more host devices, including in support of establishing HV (high voltage) operational states.

In another aspect, methods and apparatus for maintaining safety of a user while using computerized electronic devices is disclosed. In one embodiment, the methods and apparatus are configured to ensure that no single point or component failure will result in an undesired (e.g., unsafe) condition within either device.

In a further aspect, a protocol for use between a powered (sink) and powering (source) device is disclosed. In one embodiment, the protocol is configured as a predominantly sink-driven protocol. In another embodiment, the protocol is configured as a predominantly source-driven protocol. In yet another embodiment, the protocol is configured for both source- and sink-controlled aspects.

In another aspect, an integrated circuit (IC) device implementing one or more of the foregoing aspects is disclosed and described. In one embodiment, the IC device is embodied as USB controller IC device (e.g., including a PHY). In another embodiment, an ASIC (application specific IC) is used as the basis of the device. In yet another embodiment, a chip set (i.e., multiple ICs used in coordinated fashion) is disclosed. In yet another embodiment, the device comprises a multi-logic block FPGA device. In some variants, the foregoing IC includes the logic enabling selective invocation of HV-mode power delivery or receipt.

In some variants, both source and sink ICs are utilized (i.e., on respective source and sink devices) so as to enable inter-device communication across the wireline interface.

In a further aspect, a device configured to provide electrical power delivery to a second device is disclosed. In one embodiment, the device includes: a data interface configured to deliver electrical power to the second device via at least one bus; and logic in communication with the data interface and configured to, when operated: initiate validation of high-voltage operation with the second device, the validation comprising determination of a plurality of power delivery capabilities with respect to the first device, the second device, and the at least one bus; responsive to a determination that the plurality of power delivery capabilities meet a respective plurality of criteria, enable establishment of a power contract capable of operating above a specified voltage; and responsive to a determination that at least one of the plurality of power delivery capabilities fails to meet a respective condition, terminate the validation of high-voltage operation.

In yet another aspect, a method of operating a data interface between two computerized devices is disclosed. In one embodiment, the data interface is configured to deliver electrical power from one of the two computerized devices to the other, and the method includes: operating the data interface to establish a first mode, the first mode comprising first power delivery capabilities; performing a validation procedure to determine whether the interface and the two computerized devices can operate under a second mode, the second mode comprising second power delivery capabilities greater than the first power delivery capabilities; and based at least on the validation procedure, operating the data interface to establish the second mode.

In one variant, the first power delivery capabilities comprise legacy capabilities, and the second capabilities comprise high voltage (HV) capabilities not included within the legacy capabilities.

In a further aspect, improved logic state machines are disclosed for use with a wireline interface capable of power delivery. In one embodiment, corresponding state machines are utilized in both source and sink devices in order to identify, negotiate, validate and operate under one or more enhanced power delivery modes.

Other features and advantages of the present disclosure will immediately be recognized by persons of ordinary skill in the art with reference to the attached drawings and detailed description of exemplary embodiments as given below.

### BRIEF DESCRIPTION OF THE DRAWINGS

FIG. 1 is a functional block diagram of a power delivery architecture according to an exemplary embodiment of the present disclosure, including power-enhanced source and sink devices.

FIG. 1A is a functional block diagram of an exemplary mobile sink device configured according to an exemplary embodiment of the present disclosure.

FIG. 2 is a logical block diagram of a generalized methodology for providing enhanced power functionality over a data interface between devices according to exemplary embodiments of the present disclosure.

FIG. 3 is a logical block diagram illustrating an exemplary implementation of the generalized method of FIG. 2, in the context of a USB-C based interface with an enhanced HV (high voltage) mode according to an embodiment of the present disclosure.

FIG. 4 is a logical block diagram illustrating an exemplary implementation of the generalized method of FIG. 2, in the context of a USB-C based interface with an enhanced HV (high voltage) mode according to an embodiment of the present disclosure.

FIG. 5 is a ladder diagram illustrating an exemplary flow of signals and commands sent and received among high-voltage source, cable, and sink to establish a high-voltage power contact between the source and the sink, useful for explaining various aspects of the present disclosure.

FIG. 6A illustrates a logical flow diagram illustrating another exemplary flow of signals and commands sent and received among high-voltage source, cable, and sink to establish a high-voltage power contact between a source and a sink, useful for explaining various aspects of the present disclosure.

FIG. 6B illustrates a logical flow diagram illustrating another exemplary flow of signals and commands sent and received among high-voltage source, cable, and sink to establish a high-voltage power contact between a source and a sink, useful for explaining various aspects of the present disclosure.

FIG. 6C illustrates a logical flow diagram illustrating another exemplary flow of signals and commands sent and received among high-voltage source, cable, and sink to establish a high-voltage power contact between a source and a sink, useful for explaining various aspects of the present disclosure.

FIG. 7A illustrates a graphical representation of an exemplary data encoding utilized in messages and signals exchanged for validating high-voltage (HV) operation between a source and a sink in the exemplary context of USB devices according to aspects of the present disclosure.

FIG. 7B illustrates a graphical representation of an exemplary data encoding utilized in messages and signals exchanged for validating high-voltage (HV) operation between a source and a sink in the exemplary context of USB devices according to aspects of the present disclosure.

FIG. 7C illustrates a graphical representation of an exemplary data encoding utilized in messages and signals exchanged for validating high-voltage (HV) operation between a source and a sink in the exemplary context of USB devices according to aspects of the present disclosure.

FIG. 7D-1 illustrates a graphical representation of an exemplary data encoding utilized in messages and signals exchanged for validating high-voltage (HV) operation between a source and a sink in the exemplary context of USB devices according to aspects of the present disclosure.

FIG. 7D-2 illustrates a graphical representation of an exemplary data encoding utilized in messages and signals exchanged for validating high-voltage (HV) operation between a source and a sink in the exemplary context of USB devices according to aspects of the present disclosure.

FIG. 7D-3 illustrates a graphical representation of an exemplary data encoding utilized in messages and signals exchanged for validating high-voltage (HV) operation between a source and a sink in the exemplary context of USB devices according to aspects of the present disclosure.

FIG. 7E illustrates a graphical representation of an exemplary data encoding utilized in messages and signals exchanged for validating high-voltage (HV) operation between a source and a sink in the exemplary context of USB devices according to aspects of the present disclosure.

FIG. 7F illustrates a graphical representation of an exemplary data encoding utilized in messages and signals exchanged for validating high-voltage (HV) operation between a source and a sink in the exemplary context of USB devices according to aspects of the present disclosure.

FIG. 7G illustrates a graphical representation of an exemplary data encoding utilized in messages and signals exchanged for validating high-voltage (HV) operation between a source and a sink in the exemplary context of USB devices according to aspects of the present disclosure.

FIG. 7H illustrates a graphical representation of an exemplary data encoding utilized in messages and signals exchanged for validating high-voltage (HV) operation between a source and a sink in the exemplary context of USB devices according to aspects of the present disclosure.

FIG. 7I illustrates a graphical representation of an exemplary data encoding utilized in messages and signals exchanged for validating high-voltage (HV) operation between a source and a sink in the exemplary context of USB devices according to aspects of the present disclosure.

FIG. 7J illustrates a graphical representation of an exemplary data encoding utilized in messages and signals exchanged for validating high-voltage (HV) operation between a source and a sink in the exemplary context of USB devices according to aspects of the present disclosure.

FIG. 7K illustrates a graphical representation of an exemplary data encoding utilized in messages and signals exchanged for validating high-voltage (HV) operation between a source and a sink in the exemplary context of USB devices according to aspects of the present disclosure.

FIG. 7L illustrates a graphical representation of an exemplary data encoding utilized in messages and signals exchanged for validating high-voltage (HV) operation between a source and a sink in the exemplary context of USB devices according to aspects of the present disclosure.

FIG. 8 is a graph illustrating relationships among power delivery power (PDP) rating, voltage, and maximum current, including an exemplary PDP rating for HV operation according to aspects of the present disclosure.

FIG. 9 is a graph illustrating and comparing various component voltage rating ranges with resultant power according to aspects of the present disclosure.

### DETAILED DESCRIPTION

Reference is now made to the drawings, wherein like numerals refer to like parts throughout.

### Overview

In one exemplary aspect, the present disclosure provides improved methods and apparatus for enhanced (e.g., higher voltage (HV)) power delivery between wireline devices such as e.g., USB-C compliant devices) via power-delivery protocols and associated logic. The enhanced HV power delivery described herein includes delivery of electrical power to a device at a voltage and/or wattage beyond the maximum levels currently available (e.g., greater than the 20 volts and 100 watts specified in USB-C and USB PD specifications), while simultaneously assuring high levels of user and equipment safety during such operation. This capability affords a number of benefits including inter alia, accelerated charging rate of battery-powered devices, which enhances user experience and operational flexibility.

In one variant, to ensure such safe operation (e.g., to avoid fire hazards, electrical shock to the user, or similar), multiple predicate conditions relating to power delivery must be met for the source, the sink, and the cable before such delivery is permitted. For instance, cable integrity and ability to handle enhanced power transfer may be verified, and device construction must comply with “PS3” standards, as pre-conditions for HV delivery. In addition, further fail-safe mechanisms enable HV operation to discontinue upon triggering such mechanisms (e.g., timers, heartbeats). When discontinued, the source and sink may disconnect back to an unpowered state (e.g., 0 volts), or revert back to a non-HV state (i.e., maximum of 20 V and 100 W).

In one exemplary implementation of the disclosed HV delivery protocol, the source first establishes a non-HV contract with the sink via exchange of messages that indicate capabilities within the specified standard levels (e.g., at or below 20 V). The source may indicate HV capability during the initial non-HV negotiation. After a non-HV contract is established, the source may initiate a procedure for HV validation, which determines whether the source, the sink, and the cable may operate in HV conditions. The source may receive information relating to capabilities of the sink and the cable, such as whether they are PS3 compliant and maximum power delivery exceeds 100 W. If it is determined that the sink and the cable meet all applicable criteria and are thus capable of HV operation, HV is validated. Thereafter, the HV source (now deemed HV capable) may offer HV capabilities to the HV sink (now deemed HV capable) by, for example, sending a control message that includes an option for greater than 20 V (e.g., 28 V), which the HV sink may accept to establish the HV power contract.

Methods of operating the source and sink devices and associated protocols, including for instance those which are “sink-driven,” “source-driven,” or “shared responsibility,” are also disclosed, as are improved source/sink device configurations and integrated circuits.

Advantageously, the improved methods and apparatus disclosed herein may also be readily applied and adapted to other types of wireline data and power interfaces in order to afford enhanced power delivery capability (and safety), such as for example DisplayPort or HDMI interfaces.

### DETAILED DESCRIPTION OF EXEMPLARY EMBODIMENTS

Exemplary embodiments of the present invention are now described in detail. While these embodiments are primarily discussed in the context of a standardized data interface compliant with USB (universal serial bus) standards, it will be recognized by those of ordinary skill that the present invention is not so limited. Various aspects of the invention may be useful in any system interface or connection that can benefit from powering or being powered by another device (or supplying power to multiple devices), as described herein.

Power Scaling and Safety Considerations

By way of background, existing USB standards provide for the following maximum parameters (i.e., nominal, with respective tolerance bands):

TABLE 1

| | Nominal | Nominal | | Nominal | |
|---|---|---|---|---|---|
| | Maximum | Maximum | | Maximum | |
| Specification | Voltage | Current | | Power | |
| USB 2.0 | 5 V | 500 | mA | 2.5 | W |
| USB 3.0 and USB 3.1 | 5 V | 900 | mA | 4.5 | W |
| USB BC 1.2 | 5 V | 1.5 | A | 7.5 | W |
| USB Type-C 1.2 | 5 V | 3 | A | 15 | W |
| USB PD 3.0 | 20 V | 5 | A | 100 | W |

Hence, currently used standard USB connectors are limited to the power delivery capabilities listed above in Table 1. In order to achieve the enhanced power delivery beyond the present limitations of standard interfaces, certain modifications must be made.

The term “high voltage” or “HV” as used herein generally refers to a level of power delivery that is higher than the specified maximums for the relevant protocol or technology, such as those listed in Table 1 for the exemplary USB context. For example, delivering or drawing 140 W at 28 V (via, e.g., a 5 A-capable cable) may be considered HV operation.

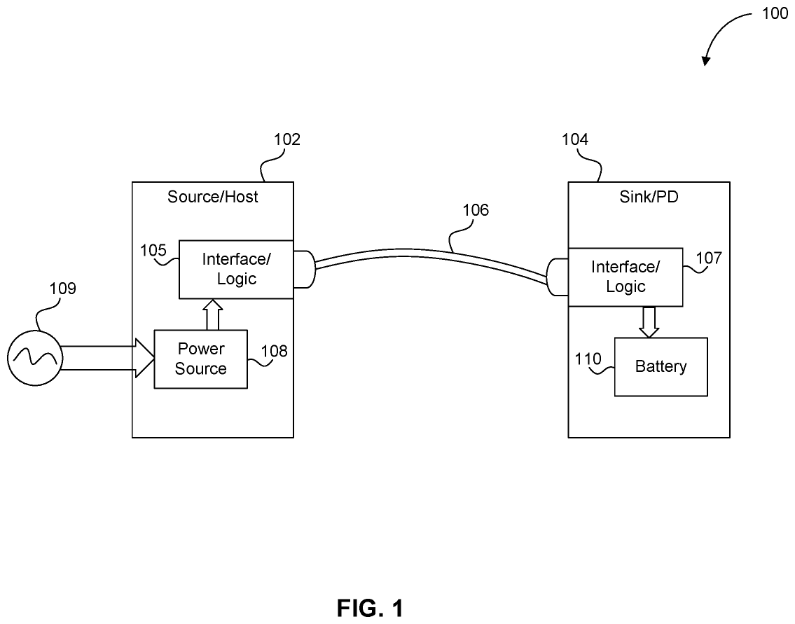

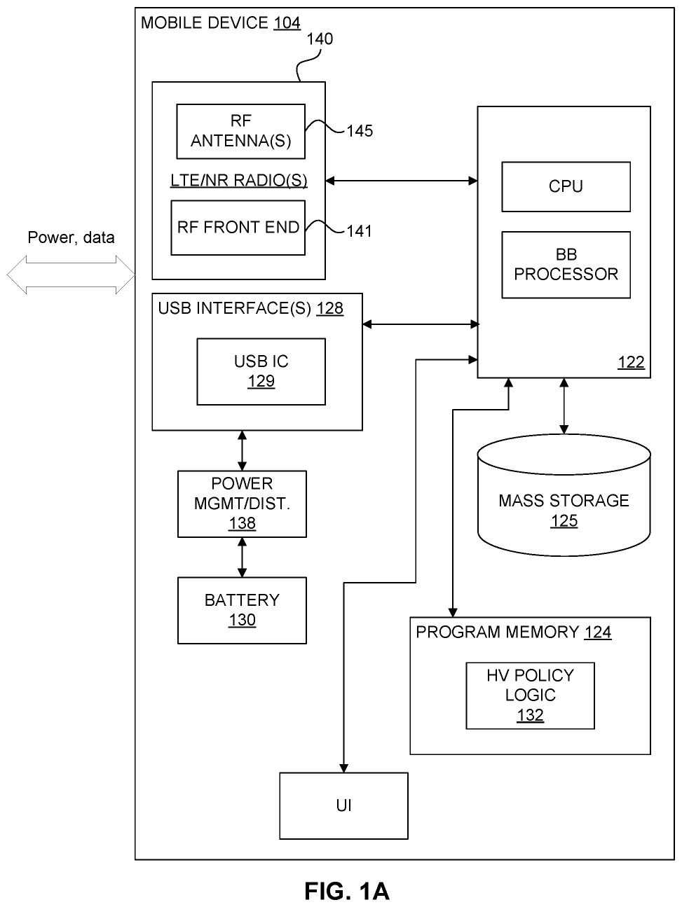

A “source” as used herein generally refers to any device that may provide electrical power to another device, such as a sink device (see FIG. 1 discussed infra). It may be, for example, a power bank (e.g., portable battery), or desktop workstations or consumer-grade electronic devices such as smartphone devices (such as, without limitation, the iPhone), personal media devices (such as, without limitation, the iPad/iPod), personal computing devices (such as, without limitation, the MacBook Pro and MacBook Air), or literally any other computing device. Although any device may be a source, within the context of many embodiments described herein, the source device utilizes a USB-C and/or USB PD port for delivering power via a cable that is capable of HV operation. A source may deliver power to multiple sink devices, some at HV and some not using HV.

A “sink” as used herein generally refers to any device that may draw electrical power, e.g., from a source device. Examples include, but are not limited to, portable electronic systems, mobile consumer devices, peripheral computing devices, and power tools. It may be any battery-powered device. It may be any of the types of devices listed with respect to the source. Although any device may be a sink, within the context of many embodiments described herein, the sink device utilizes a USB PD-capable USB-C port for receiving power via a cable that is capable of HV operation.

As discussed previously, safety rules must also be observed in the design and operation of electrical and/or electronic devices and elements. Various relevant standard requirements include, but are not limited to, IEC 61508:2010, IEC 62368-1:2018, and IEC 62368-3:2017.

Further, power sources, power source equipment (PSE), and circuitry may be classified into three different classes: Class 1, Class 2, and Class 3. Briefly, a Class 1 power source (PS1) is limited to 15 W or below, measured after three (3) seconds, and does not require any special fire enclosure construction. A Class 2 power source (PS2) is limited to 100 W or below, measured after five (5) seconds, and does not require any special fire enclosure construction. A Class 3 power source (PS3) is, in the context of USB, not limited to 100 W but requires fire enclosure construction.

Class 3 power sources operating above 100 W are guided by IEC 62368-3:2017, which states: “[f]or interconnection of DC power transfer PSE circuits to other equipment, via either direct plug-in connectors or via fly leads, where it is unknown that the attached devices are likely to comply with IEC 62368-1, the delivered power shall comply with either PS2 or Clause Q.1 of IEC 62368-1:2014”. Therefore, to reach power levels above 100 W, attached devices and cables must be known to likely comply with PS3 fire enclosure construction requirements. Such compliance must also occur in all devices involved in interconnection, e.g., between a host device and an attached device (e.g., between source and sink devices, between host and peripheral devices, between host and another host device). In the past, compliance has often been achieved via use of propriety connectors particularly engineered for such considerations; however, for standardized form factors such as USB, such approach is not available.

Many non-PS3 rated USB-C sinks and cables are currently deployed, and more will be developed in the future. As such, a mechanism must exist to prevent PS3-capable USB-C sources from sourcing greater than 100 W to non-PS3-rated sinks and cables, except under strict circumstances. Software (e.g., instructions, exchange of messages) may be used to validate that a sink is known to be likely compliant to appropriate fire ratings, as well as power capabilities of the source and the cable. USB PD can be used to validate that both an attached cable and an attached sink are likely compliant to >100 W.

Moreover, safety standards generally follow the guideline that there must be multiple points of failure before an unsafe condition occurs. Generally, the more hardware and/or software conditions that must concurrently fail before an unsafe condition occurs, the better for device operation. That is, no single-point failure should produce an unsafe condition. Thus, the validation of high-voltage operation as will be described below must meet a minimum of two separate and independent steps, ideally several more than two, thereby allowing use of a standard (e.g., USB-C) connector and be reasonably assured it is safe to operate at a higher-than-specified voltage without causing hazards such as fire.

Exemplary System Architecture

With the foregoing as a backdrop, FIG. 1 illustrates an embodiment of an exemplary system architecture configured for enhanced power management and concurrent observation of relevant safety standards and requirements, according to the present disclosure.

As shown, the system 100 includes a source/host device 102 coupled to a sink or powered device 106 via a wireline interface such as a cable 106. Each device 102, 104 includes respective interface hardware and logic 105, 107 as described in greater detail infra, which support transactions and delivery of electrical power across the cable 106. The source device 102 further includes an electrical power source 108 (e.g., a power supply which converts AC current from an external source 109 to e.g., DC voltages that are stepped down for use within the host/source device, and ultimately a portion of which may be delivered to the sink 104 using for instance the enhancements described herein. As such, the power supply 108 is rated for at least the power required by the host 102 for its operation, as well as that which can be maximally delivered to the sink(s) (one shown only, for clarity), including any electrical losses such as via I²R, design and operational margins, and similar. It will be appreciated that while the host is shown as having a power source 108, it may also have a battery or other storage device for electrical energy, and as such the present disclosure contemplates instances wherein both source and sink are battery powered, and with sufficient battery sizing, the source may supply one or more sinks from energy derived from storage in its battery alone (such as where both devices 102, 104 are mobile device unconnected from any AC source). Yet other configurations and applications will be recognized by those of ordinary skill given the present disclosure.

Moreover, the present disclosure contemplates configurations of the source and sink devices which enable “role reversal.” For example, in one such configuration, the source 102 and sink 104 each include within their power enhancement and interface management logic code (e.g., firmware/software) which enables each device to assume either role in any given connection via a cable 106; e.g., the sink can become the source, and the source can become the sink, including assumption of particular protocol roles as described subsequently in greater detail. For instance, a host or source which at one time is AC-powered, and connects to the sink to supply power thereto, can subsequently (e.g., upon disconnection from the AC source 109) assume a sink role when it's battery is depleted, and be charged or otherwise supplied power from the (former) sink device 104, which may or may not at that point be AC-powered.

It will also be recognized that the “connected” devices 102, 104 of FIG. 1 (i.e., those which are physically connected to one another via the cable 106) may act as proxies or intermediaries for other “endpoint” devices with which they themselves maintain data communication. For instance, the source device 102 may be an intermediary or proxy for an endpoint device, and likewise the sink 104 may be a proxy for another connected device. As such, various such “pass through” configurations are also contemplated by the present disclosure.

It will yet further be appreciated that the source device may take on other configurations and form factors; e.g., the logic of the interface and enhanced/HV capability described herein may in fact be encapsulated within a “smart” or power-adaptive AC wall plug or power converter with e.g., wireline (e.g., USB) interface thereon, such as the type generally manufactured by the Assignee hereof.

Similarly some of even all of the logic components necessary to manage, validate and cause supply of the enhanced power capabilities can be incorporated into the cable itself, such as where the standardized (e.g., USB) terminal and contact portions are maintained, yet the physical housing around them is expanded to contain the added logic. For instance, one end of the cable may be tethered to a source or sink, and could then contain the appropriate circuitry.

### Exemplary Mobile Apparatus

FIG. 1A illustrates a block diagram of an exemplary embodiment of a mobile device, such as a smartphone or tablet device configured as a 3GPP UE, useful for operation in accordance with the present disclosure. It will be recognized that while an exemplary sink mobile device 104 is illustrated and shown, a host/source may be comparably configured by one of ordinary skill for operation consistent with the various aspects described herein, the mobile device 104 being merely exemplary and illustrative of the broader principles.

As shown, the mobile device 104 includes one or more USB interfaces 128, including one or more supporting ICs 129 (e.g., for management of PHY and other functions such as Layer 2/3 functionality). In this embodiment, the interface 128 is USB-C compliant (as well as backwards compatible with other predecessor standards and protocols), although such compliance/compatibility is not a requirement of practicing the disclosure. It will be recognized that while a single interface 128 is shown for clarity, the mobile device 104 (and in fact the host 102 of FIG. 1) may include multiple interfaces/ports, such as where the device 102, 104 can connect to multiple devices simultaneously and transact power/data therewith simultaneously. As such, the present disclosure contemplates utilization of logic on such devices to evaluate and manage power delivery and consumption across all such interfaces, consistent with battery, power supply, cabling, or other physical limitations of such devices (e.g., to ensure that multiple sink devices connected to a host do not exceed the maximum rating of the power supply of the host), and in some cases “intelligently” manage division of available host power resources across the various devices based on e.g., extant battery charge of the sink devices, type of device, and/or other considerations.

In one exemplary embodiment as shown, the mobile device (UE) 104 further includes, inter alia, a processor apparatus or subsystem 122, a program memory module 124, UE HV policy and management logic 132 (here implemented as software or firmware operative to execute on the processor 122), and wireless interfaces 140 for communications with the relevant RANs (e.g., 4G/4.5G E-UTRAN and 5G-NR RAN, respectively, as well as WLAN and BLE or other such ancillary interfaces—not shown). The RF interfaces 140 are each configured to comply with the relevant PHY standards which it supports. The antenna(s) 145 of the UE radios may include multiple spatially diverse individual elements in e.g., a MIMO- or MISO-type configuration, such that spatial diversity of the received signals can be utilized.

In one embodiment, the processor apparatus 122 includes one or more of a baseband processor (BB), digital signal processor, microprocessor, field-programmable gate array, GPU, or plurality of processing components mounted on one or more substrates. The processor apparatus 122 may also comprise an internal cache memory. The processing subsystem is in communication with a program memory module or subsystem 124, where the latter may include memory which may comprise, e.g., SRAM, flash and/or SDRAM components. The memory module 1804 may implement one or more of direct memory access (DMA) type hardware, so as to facilitate data accesses as is well known in the art. The memory module of the exemplary embodiment contains one or more computer-executable instructions that are executable by the processor apparatus 122. A mass storage device 125 (e.g., NAND/NOR flash or the like) is also provided as shown.

The processor apparatus 122 is configured to execute at least one computer program stored in memory 124 (e.g., the logic of the enhanced power management functions, in the form of software or firmware that implements the various functions described herein). Other embodiments may implement such functionality within dedicated hardware, logic, and/or specialized co-processors (not shown).

Also included in the UE 104 may be a USIM apparatus (not shown), which is configured to securely store (and provide ancillary processing related to), which enables the UE to register within one or more 3GPP PLMNs. The USIMs may be virtual or physical (e.g., a physical SIM or micro-SIM card, or an eSIM stored in a secure element or SE), and moreover non-SIM based variants are also contemplated herein.

In some embodiments, the UE policy logic 132 also utilizes memory 124 or other storage 125 configured to temporarily hold a number of data relating to the various functions relating to implementation of enhanced power management and delivery, role assumption and assignment, voltage selection, conditions wherein the HV mode is exited, and the like, as discussed in greater detail below. It will be appreciated that the HV logic and policy data may be changed (e.g., re-flashed”) after manufacture of the device, such as via data received OTA via one of the wireless links, which may alter or update the logic and/or policy, as well as the aforementioned supporting data resident on the device.

In other embodiments, the HV policy and management logic 132 may be disposed all or in part on the IC 129 of the wireline (e.g., USB) interface, including division of functionality or routines such that lower-level operations are handled by the interface IC 129 and its indigenous logic, and higher-level policies or operations management are handled by the logic 132 resident on e.g., the program memory of the device 104. For instance, lower-layer protocols for device detection, negotiation, presentation for available HV voltage values, and similar may be handled by the interface IC logic, while conditions or policies such as which devices may be powered under enhanced (HV) mode when connected, user preferences on charging, control of charge rates based on available AC source or battery capacity, and the like may be managed by the higher-layer logic. Various other schemes may be implemented as will be appreciated by those of ordinary skill given this disclosure.

### Exemplary Methods

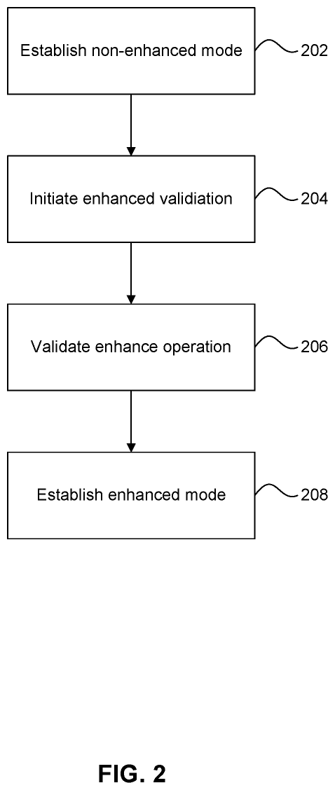

Referring now to FIG. 2, one exemplary embodiment of a generalized methodology for providing enhanced power over a data interface between devices is described.

At step 202, a non-enhanced mode (e.g., legacy) mode of operation across the interface is established. As described in greater detail below, in certain embodiments, this interface may be a USB-C compliant interface, and the non-enhanced mode comprises power delivery at or below 20V/100 W.

Per step 204, an enhanced mode validation procedure is initiated. This procedure will, if passed or completed, enable the interface to enter the enhanced mode of operation from the non-enhanced mode.

Per step 206, the enhanced mode of operation completes validation, thereby enabling the interface to enter the enhanced mode.

Lastly, per step 208, the enhanced mode of operation between the devices over the interface is established such that, e.g., higher voltages and power levels can be used across the interface.

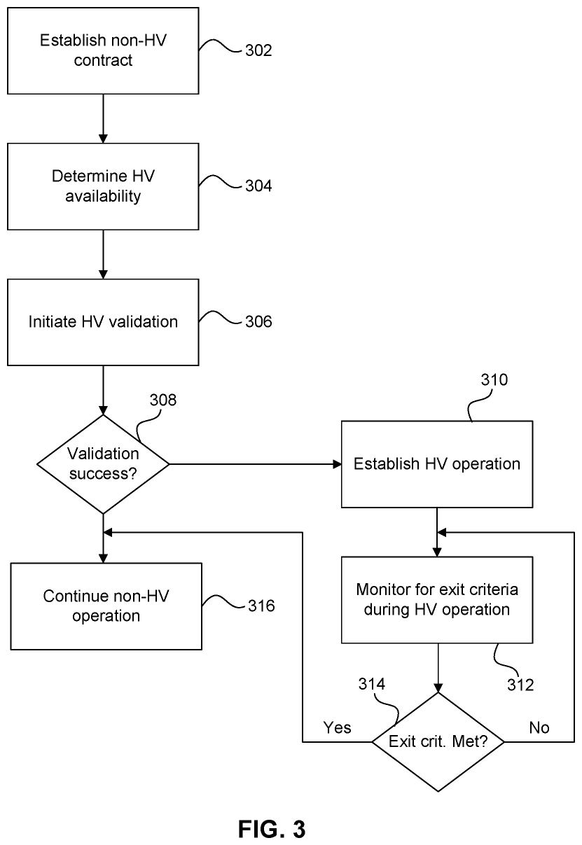

Referring now to FIG. 3, one implementation of the generalized method of FIG. 2 is shown and described, specifically in the context of an enhanced HV (high voltage mode) over an exemplary USB-compliant interface.

At step 302, a source device may initiate and establish a first (non-HV) power “contract” by negotiating with a sink device. A “contract” as referred to herein may refer to a result of handshake negotiations between two or more devices that are connected to each other, wherein the devices communicate various information relating to power and power delivery, such as how much power a source device may support, and how much power the device being charged (i.e., the sink) may handle. A contract is established if the devices acknowledge the power delivery parameters, and may be discontinued upon detection of, e.g., error or fault conditions.

In one approach, the source device and the sink device are coupled with a USB-C cable via USB-C ports configured to send and receive electrical power according to USB PD.

At step 304, it is determined whether the source is capable of HV operation. For example, a “Source_Capabilities” message may be checked to see that the source has set the bit indicating that it supports HV operation. In one exemplary implementation, the sink may determine whether the source is capable of HV operation. If the source has not indicated that it is capable of HV operation, the source and sink maintain the non-HV contract and does not attempt to establish an HV contract.

At step 306, based on the determination that the source is capable of HV operation, validation of a second (HV) power contract between the source device and the sink device is initiated.

Per step 308, the method determines whether validation of the HV mode was successful. If so, the method proceeds to step 310, wherein HV operation over the interface is established and power transacted according to the enhanced mode (e.g., at voltage greater than 20V and power greater than 100 W). As described in greater detail below, this may also include operation in/transition to and from various sub-modes thereof, including various different voltages/power levels if needed.

Per step 312, during enhanced mode operation, the “interface” is monitored for one or more triggering criteria which would cause or necessitate exit from the enhanced mode. As used in this context, the monitoring of the interface may include monitoring of one or more source criteria, monitoring of one or more sink criteria, one or more cable criteria, monitoring of higher layer device management logic (of the type discussed previously), and/or yet other conditions. Advantageously, the methods and apparatus described herein can be adapted to any number of different logic paradigms and policies for enhanced mode operation, as well as implementation of safety-related considerations (e.g., detection of device or component failure, unsafe operating conditions, etc.) which may be used to force exit from the enhanced mode.

Per step 314, the exit criteria are evaluated and if met, the interface exits the enhanced mode, which in one variant means continuation or reversion to the prior non-HV mode per step 316.

As discussed previously, safety standards generally follow the guideline that when a fault occurs within an electrical device, the system fails if at all possible into a “safe” condition. To achieve safe operation at above 100 W for the exemplary USB-C interface applications, the sourcing voltage may be removed upon detection of one or more errors or faults. Such errors or faults may include expiration of a timer, or failure to meet capability criteria (e.g., sink cannot handle >20 V). Hence, alternatively per step 314 above, depending on the type of exit condition detected, the interface may be selectively dis-established, or enter another state as opposed to reverting to non-HV mode operation.

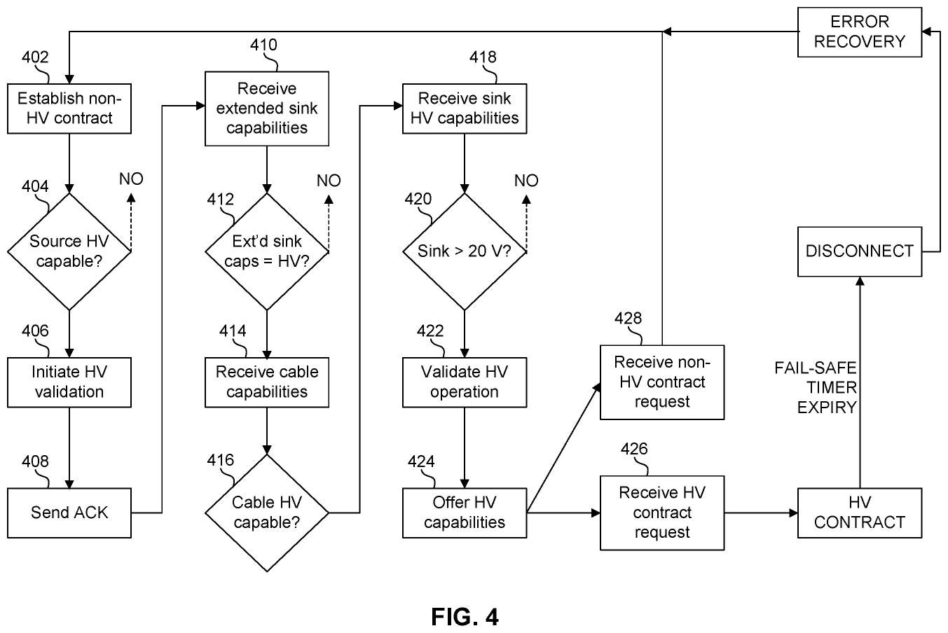

Referring now to FIG. 4, yet another implementation of the generalized method of FIG. 2 is shown and described, again specifically in the context of an enhanced HV (high voltage mode) over an exemplary USB-compliant interface.

At step 402, a source device may initiate and establish a first (non-HV) power contract by negotiating with a sink device. In one approach, the source device and the sink device are coupled with a USB-C cable via USB-C ports configured to send and receive electrical power according to USB PD. During the initial negotiation, the source may offer various source capabilities, such as voltages up to 20 V. These are non-HV capabilities. The source may also send a message indicating whether or not it supports HV operation above 20 V (e.g., a yes/no flag, or bit within a “Source_Capabilities” message). The source may also request a response as to whether the sink supports HV. The sink may send a “Request” message; the source may Accept, and thereafter establish a non-HV contract with the sink, which is limited to 20 V and 100 VA (watts).

At step 404, it is determined whether the source is capable of HV operation. For example, the “Source_Capabilities” message may be checked to see that the source has set the bit indicating that it supports HV operation. In one exemplary implementation, the sink may determine whether the source is capable of HV operation. If the source has not indicated that it is capable of HV operation, the source and sink maintain the non-HV contract and does not attempt to establish an HV contract.

At step 406, based on the determination that the source is capable of HV operation, validation of a second (HV) power contract between the source device and the sink device is initiated. The source device may receive a request for HV validation. The sink may send such request, e.g., via a “Request Source_Cap_HV” or other message.

At step 408, responsive to the request for HV validation, the source may send an acknowledgment signal (ACK) back to the sink to acknowledge that the source supports HV validation.

At step 410, the source may receive extended sink capabilities from the sink. For example, a “Get_Sink_Cap_Extended” message returns information on whether the sink has a SKEDB version of greater than 1.0, whether the sink is PS3 compliant, and whether the sink's maximum power delivery power (PDP) is greater than 100 W. In the exemplary embodiment, all three conditions must be met to proceed with HV validation. In other embodiments, other conditions may be imposed; e.g., PDP must be greater than 140 W. In some variants, some criteria may be relaxed at least temporarily; e.g., PS3 compliance may not be required for emergency power sourcing to keep a sink device operating during critical operations (e.g., system updates). These criteria may hence be dynamically determined based on application or use case (different PDP, relaxed conditions, etc.).

At step 412, it may be determined (e.g., by the source) whether all three extended sink capabilities meet the criteria for HV operation. If not, the HV validation process ceases and returns the source and sink to the non-HV state.

If so, at step 414, the source may receive cable capabilities from the cable. For example, a “Get_Cable_Cap” message returns information on whether the cable is PS3 compliant, the maximum voltage and/or the maximum current the cable may handle, and/or whether the cable capabilities are compatible with the source.

At step 416, it may be determined (e.g., by the source) whether all the cable capabilities meet the criteria for HV operation. If not, HV validation ceases and returns the source and sink to the non-HV state.

At step 418, the source may receive the sink's HV capabilities (now prospectively determined to be HV capable). For example, a “Get_Sink_Cap_HV” message received from the sink may include what voltages above 20 V are supported by the sink, whether the supported voltages are above 20 V, and/or whether the sink voltages is supported by the source (and if so, which ones).

At step 420, it may be determined (e.g., by the source) whether sink voltages exceed 20 V (as required for HV operation) and whether the sink voltages are supported by the source. If not, HV validation ceases and returns the source and sink to the non-HV state.

If so, at step 422, HV operation is validated. However, note that at any point after, during, or before validation, if a fail-safe condition is triggered, the source and sink may disconnect electrically (VBUS=0 V), or return to the non-HV contract.

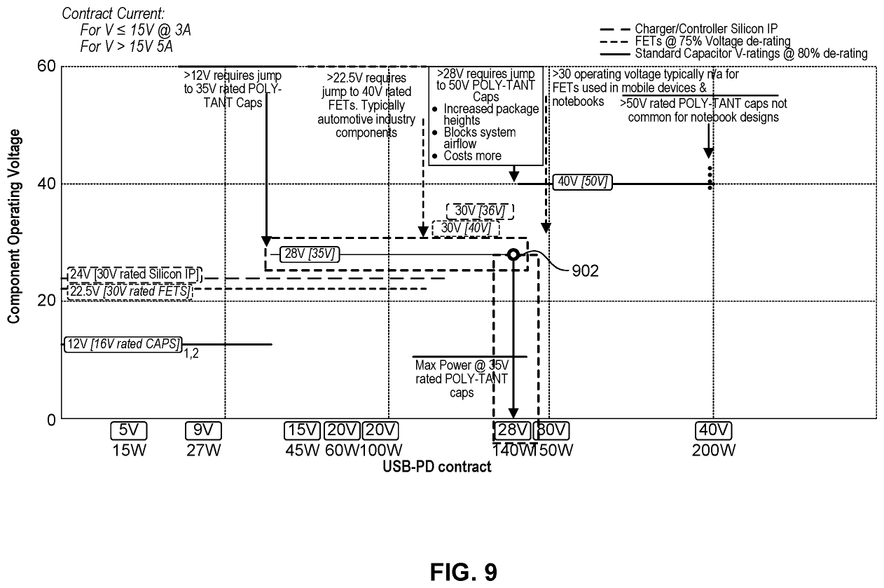

At step 424, responsive to HV validation, the source may offer capabilities including HV voltages. For instance, the source may transmit a “Source_Capabilities_HV” message containing all available voltages, e.g., 5, 9, 15, 20, and now, 28 V. It will be appreciated that 28V is selected merely as an expedient (i.e., is a value which meets the desired aims of enhanced charge rate and power delivery, while maintaining compatibility with other extant electronic components and safety requirements), and in fact other voltage values—including multiple stepped increments of voltages above 20V—may be used consistent with the present disclosure. Advantageously, 28V components are commoditized and are readily available outside of typical USB-C usage and as such, selection of scaled voltage values for use in the interfaces described herein which leverage such commoditization also advantageously reduce design and production costs. However, one will readily appreciate given the contents of the present disclosure that other voltage and wattage levels may be possible, limited by the capabilities of the hardware (including source, sink, and cable) and demands of the application. See also FIG. 9, discussed infra.

At step 426, the sink may request HV contract. The sink may send a “Request_HV” (as opposed to a non-HV “Request”) message to negotiate the HV contract to operate at 28 V.

During the HV contract, the sink (and/or the source) may employ “heartbeat” signals to continuously engage in the HV contract. That is, HV contract may not be a permanent or persistent state; upkeep is required for as long as HV operation is needed. Failure to receive one or more heartbeat messages may result in error, disconnection back to 0 V, and/or reversion back to a non-HV state (i.e., maximum of 20 V and 100 W).

Similarly, it will be appreciated that other mechanisms for keeping the enhanced (HV) state “alive” or persistent may be used consistent for the disclosure. For instance, one device may poll or query the other at a prescribed periodicity or on an event-driven basis. An extant or new scratchpad register or other such storage device may also be used, such as where one device writes to the register/memory, and the other device periodically reads it to determine state.

In addition, in the exemplary embodiment, a plurality of timers such as those described elsewhere herein may be initiated (e.g., a source HV validation timer “SrcHVValidationTimer”, a source HV communications timer “SrcHVCommsTimer”, and a sink HV communications timer “SnkHVCommsTimer”). Expiration of any of these timers may cause the HV contract to terminate in an error and/or cause the source and sink to disconnect back to 0 V or revert back to a non-HV state.

Other error recovery or reset procedures may be initiated, such as those described elsewhere herein. Moreover, these fail-safe mechanisms may be implemented or triggered at any point during HV validation or any point during HV operation.

At step 428, the sink may alternatively request a non-HV contract via a “Request” (as opposed to an HV “Request_HV”) message. Alternatively, if the source offers a “Source_Capabilities” (as opposed to a “Source_Capabilities_HV”) message at any state, then the sink may return the non-HV “Request”, thereby leading to termination of HV validation.

It will be appreciated that while the source and sink devices 102, 104 may exchange the exemplary message types as noted above, naming of message types is wholly arbitrary, and literally any type of message may be used to signal enhanced (e.g., HV) availability, capabilities, etc., depending on the context of the protocol being enhanced. Alternatively, or in conjunction with the messages described above, other means of signaling may be used, such as writing data to a shared register, or a shared memory between the source and the sink (or processor apparatus operable therein). In some variants, transfer descriptors (TDs) and completion descriptors (CDs) may be transmitted and received between source and sink devices to exchange payloads (e.g., messages), or to describe or point to such data by writing to transfer descriptor rings (TDRs) and completion descriptor rings (CDRs).

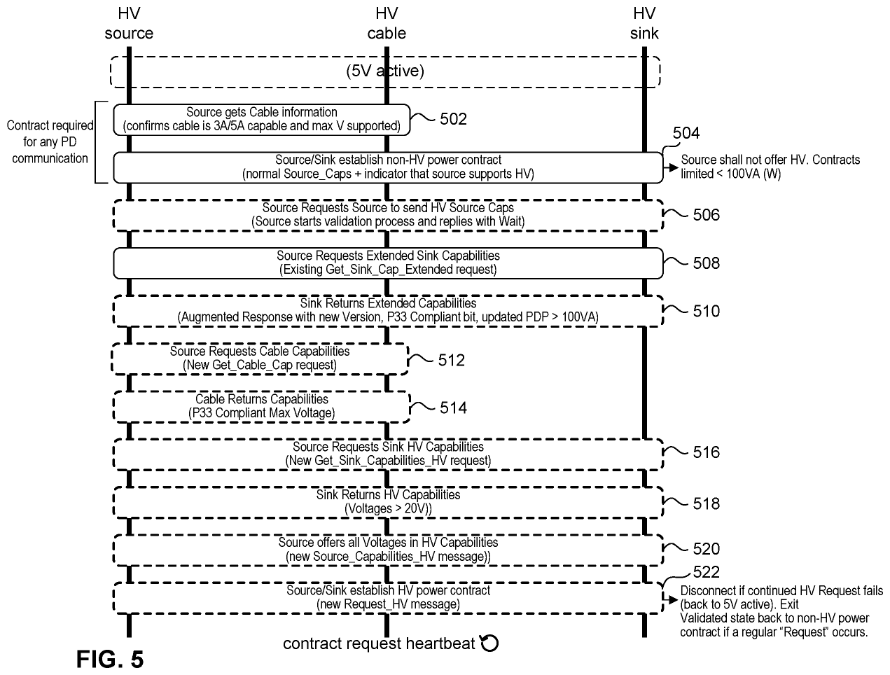

FIG. 5 is a ladder diagram illustrating an exemplary flow of signals and commands sent and received among high-voltage source, cable, and sink to establish a high-voltage power contact between the source and the sink, within the exemplary USB-C context referenced above. One of ordinary skill in the relevant art will appreciate, however, given the contents of the present disclosure that the operations involved herein need not necessarily occur in the order presented below. Moreover, in some embodiments, some operations may occur in parallel or contemporaneously, or otherwise effectuate a response or action in parallel. For example, a source may transmit signals to both a sink and a cable at the same time or within a given time period (e.g., within x milliseconds).

As shown in FIG. 5, at operation 502, the source may receive or identify information about the cable. In one embodiment, the source is configured to confirm that the cable is capable of driving 3 A or 5 A and has a maximum voltage rating that will support, e.g., 28 V.

At operation 504, the source and/or the sink may establish a non-high-voltage (non-HV) power contract. That is, the source initially does not offer high-voltage (HV) power delivery over 100 W, and as such, power delivery contracts are limited to 100 W at most. In various implementations, operations 502 and 504 are necessary steps to negotiate a contract for any USB PD communication.

At operation 506, the sink requests the source to send HV source capabilities (the source starts the validation process and replies with “Wait”) using a Get_Source_Cap_HV” message. It will be appreciated, however, that virtually any new message may be used to request that the source start HV validation. For example, in another embodiment, a message “Request_HV_Validation” may be sent from the sink to the source.

At operation 508, the source may request extended sink capabilities. For example, a “Get_Sink_Cap_Extended” request may be sent from the source to the sink.

At operation 510, the sink may return, indicate, and/or initiate extended capabilities. The sink may send a response with additional information, such as new version, PS3-compliant bit, or updated capabilities (e.g., greater than 100 W).

At operation 512, the source may request cable capabilities from the cable. For example, a “Get_Cable_Cap” request may be sent from the source to the cable.

At operation 514, the cable may return its capabilities to the source. Such a response may include information regarding PS3 compliance and maximum voltage rating.

At operation 516, the source may request HV capabilities from the sink. For example, a “Get_Sink_Capabilites_HV” request may be sent from the source to the sink.

At operation 518, the sink may return HV capabilities to the source and/or the cable. More specifically, the sink may indicate that the new maximum voltage is greater than 20 V. In one specific embodiment, the new maximum voltage may be 28 V. In another embodiment, the new maximum voltage may be set to greater than 28 V, accounting for voltage de-rating. For instance, if de-rating is 80%, a 35V component will operate at 28 V. At this point, HV operation may be validated and ready to request.

At operation 520, the source may offer all voltages in HV capabilities from, e.g., its USB ports. For example, a new “Source_Capabilities_HV” message may be sent from the source to the sink and/or the cable.

At operation 522, the source and the sink may establish the new HV power contract, so as to allow enhanced power delivery at, e.g., the HV capabilities set at operation 518. For example, a “Request_HV” message may be exchanged, e.g., sent from sink to source in one exemplary embodiment.

In addition, the HV contract may enable the sink or the source to initiate or request a heartbeat, or cause a heartbeat to be exchanged among the source, the sink, and/or the cable such that the contract is continually being enforced at the newly negotiated rating. Such heartbeats may include a request to maintain the HV contract at every predetermined time period. In some embodiments, the time period may be dynamically determined based on, e.g., usage amount (e.g., less use, less frequent heartbeat), voltage level (e.g., higher the voltage, the more frequent the heartbeat), or other indications that maintained HV is needed. If continued heartbeat does not occur, it may be indicative that the source and the sink are no longer in communication or no longer in need of power delivery. Based at least on such indication, the HV contracting may be discontinued (e.g., source disconnects to 0 V), and/or the non-HV power contract may be restored back to a maximum of 100 W and 5 V. In some embodiments, if a “regular” request affirmatively occurs, the HV contract falls back to the non-HV state.

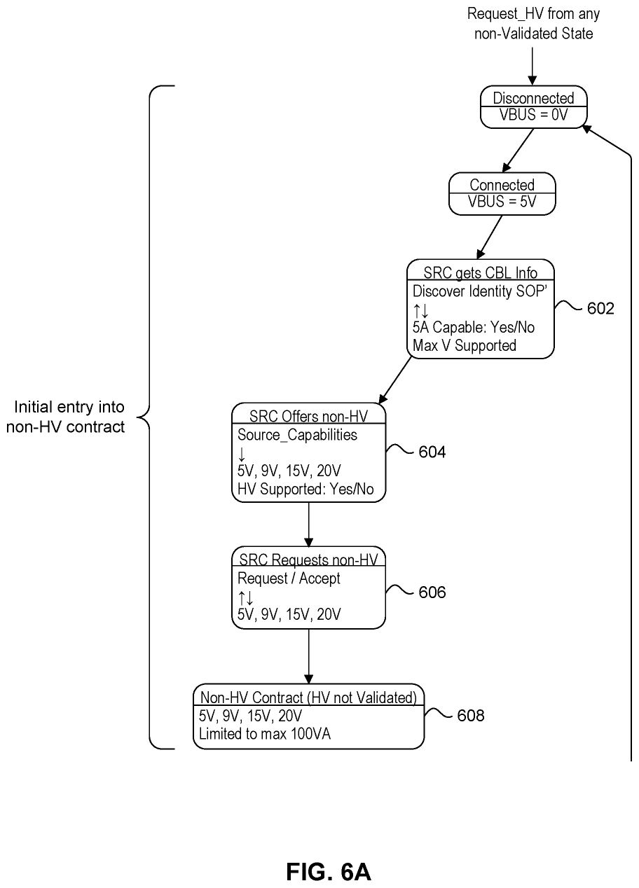

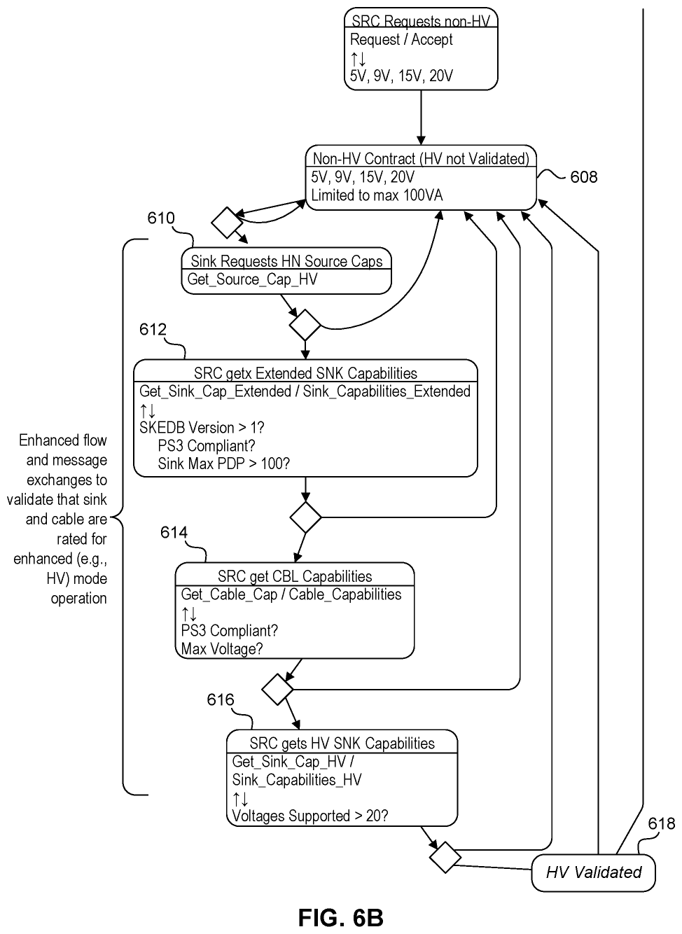

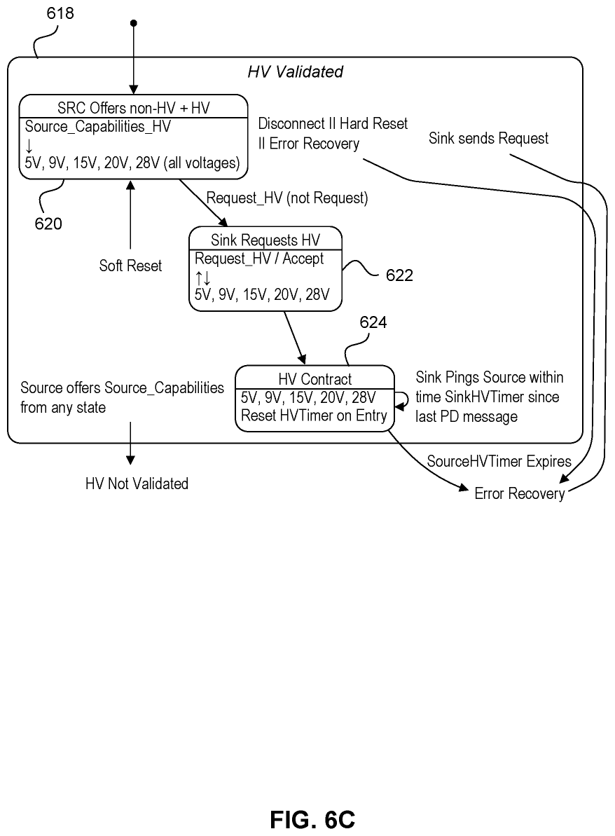

FIGS. 6A-6C are logical flow diagrams illustrating exemplary implementations of signals and commands sent and received among high-voltage source, cable, and sink, in order to establish a high-voltage power contact between the source and the sink. One of ordinary skill in the relevant art will appreciate, given the contents of the present disclosure, that the operations involved herein need not necessarily occur in the order presented below, and in fact the order of steps may be permuted and/or performed generally in parallel (consistent with hardware and other limitations of the interface itself). For instance, in some embodiments, some operations may occur in parallel or contemporaneously, or otherwise effectuate a response or action in parallel. For example, a source may transmit signals to both a sink and a cable at the same time or within a given time period (e.g., within N milliseconds).

Additionally, while certain exemplary state transitions are illustrated in this embodiment (e.g., disconnect with hard reset as shown in FIG. 6C), other options may be substituted depending on the particular application and logic desired.

Moreover, it will be appreciated that while multiple conditions may be requested within one message or request, utilizing separate messages for such data exchanges may increase the number of independent conditions or “stages” that may each be used as a gating criterion or condition precedent; e.g., may cause the HV negotiation to fail, thereby increasing safety, and potentially reducing the need to check for multiple conditions at once; e.g., if the first portion of a set of condition is evaluated and fails, there is no need to evaluate the remainder of the set of necessary conditions. As discussed above, it is desirable in all modes of operation that occurrence of component or other type of failure will cause reversion of the interface (and participating devices) into a safe condition such as a disconnect to V_{BUS}=0 V or a drop to a safe condition such as an operation below 100 W.

Generally speaking, in order to implement the increased power delivery described herein in the context of USB PD, new commands and/or signals which may not be supported by non-PS3 equipment (e.g., cables and sinks) may be required depending on the particular application. As such, part of the design philosophy of the exemplary signals and commands described in detail below is the inclusion of multiple independent protocol steps, including new commands and responses (e.g., newly defined control messages), which are used to validate a cable separate from a sink. Similarly, multiple independent steps including new commands and responses are utilized to validate a sink separate from a cable. These multiple independent steps must each succeed, so as to ensure proper and safe HV mode operation consistent with the guidelines set forth supra.

In one exemplary embodiment, as shown in FIG. 6A, the sink and source establish a non-high-voltage (non-HV) contract from a disconnected 0V state. First, a “Request_HV” request may be received from any non-HV-validated state to initiate high-voltage (resulting in above 100 W) operation. At step 602, after the bus (e.g., cable) is connected, the source receives cable information. Information such as whether the cable is 5 A capable (e.g., yes/no flag) and whether the maximum voltage (e.g., 28 V) is supported may be received by the source. At step 604, the source may offer non-HV voltages. In order to enable various features of the present disclosure, the source may trigger a flag (e.g., “HV Supported” flag) or set a bit (e.g., in a shared register in shared memory or message transmitted to the sink) that indicates whether or not HV operation is supported. Contrast with typical non-HV negotiations where HV capability (i.e., above 20 V and 100 W) is not offered at any point during negotiation. In various implementations, the source may offer 5V, 9V, 15V and/or 20V capabilities, and set a “HV supported” flag to “yes” or “no” (indicating that the source is capable of HV operation or not, respectively).

At step 606, the sink may request non-HV operation. In one embodiment, the sink may wait for the request to be accepted by the source.

At step 608, the non-HV contract may be established between the source and the sink (e.g., at one or more of the capabilities offered above). HV operation is not validated at this state, and maximum power delivery is limited to 100 W. As noted supra, establishing a non-HV contract may be required before proceeding with HV contracting.

Continuing to FIG. 6B, an expanded command sequence subsequent to establishing the non-HV contract is performed to validate that the sink and cable are rated for HV operation (i.e., beyond 100 W).

As alluded to elsewhere herein, in one exemplary embodiment, the following steps contain multiple conditions that must all be met for HV operation to be validated. For safety considerations, e.g., fire hazards and personnel shock considerations, it is generally desirable to implement multiple “fail-safes” (e.g., no single component failure can by itself cause an unsafe condition), so as to minimize such hazards during enhanced high-voltage and/or high-wattage electronic operations operation beyond 20 V and 100 W. However, it will be appreciated that in certain situations, one or more requisite conditions may be waived at least temporarily, such as during debug, testing, or to draw emergency power sourcing to keep a sink device (or multiple sink devices) operating during critical operations (e.g., system updates). In such cases, as an example, PS3 compliance may not be required during that transient/temporary period. However, it is generally desirable to impose multiple criteria to ensure safe operation.

At step 610 (FIG. 6B), the sink may request HV source capabilities from the source via a “Get_Source_Cap_HV” request. In one embodiment, the source may indicate HV support prior to this request; if there is no such indication, the HV negotiation may fail at this point, and non-HV contract may be maintained.

At step 612, the source receives extended sink capabilities from the sink via a “Get_Sink_Cap_Extended” or “Sink_Capabilities_Extended” message. The source may check for a PS3-compliant bit, and maximum power delivery of the sink of greater than 100 W. Applicable software versioning of, e.g., SKEDB for USB-C, may be checked also, where various embodiments of the present disclosure require a SKEDB version above v1.0 in order to operate in HV. In one embodiment, the source may indicate HV validation prior to this receiving the extended sink capabilities prior to this message; if there is no such validation, the HV negotiation may fail at this point, and non-HV contract may be maintained.

At step 614, the source may request cable capabilities from the cable via a “Get_Cable_Cap” or “Cable_Capabilities” request message. The source may again check for PS3-compliance (e.g., via a bit in the message) and maximum power delivery of the cable being greater than 100 W. Additional capabilities may be checked, such as maximum current that the cable can handle, and whether the cable is compatible with the source. In one embodiment, the source may check that the sink capabilities exceed these newly extended parameters prior to this request; if the sink does not meet one or more of these parameters fail to exceed the new parameters, the HV negotiation may fail at this point, and non-HV contract may be maintained.

At step 616, the source may receive HV sink capabilities via a “Get_Sink_Capabilites_HV” or “Sink_Capabilites_HV” request message. The source may check that the voltages supported include voltages greater than 20 V. In one embodiment, the source may check that the cable capabilities exceed these newly extended parameters prior to identifying the extended sink capabilities; if the cable does not meet one or more of these parameters fail to exceed the new parameters, the HV negotiation may fail at this point, and non-HV contract may be maintained.

At step 618, the HV operation may be validated. In one embodiment, the source may check that the sink voltage capabilities exceed 20 V; if not, the HV negotiation may fail at this point, and non-HV contract may be maintained.

Turning now to FIG. 6C, once HV operation is validated, the source may offer HV capabilities, in addition to non-HV capabilities, at step 620. For example, in addition to the non-HV voltages identified prior to a successful HV contract negotiation (5 V, 9 V, 15 V and/or 20 V), a new voltage of 28 V may be set and available by the source.

The sink may request HV or non-HV operation. If the sink requests HV, via, e.g., a “Request_HV” request, the HV power contract is established at step 622. The sink may thereafter draw power above (or below) 100 W.

In one embodiment, an HV timer is initiated. Upon expiration of the HV timer, HV operation may be discontinued (e.g., source disconnects to 0 V), suspended, or downgraded to 20V operation. In another embodiment, the sink implements a heartbeat wherein it renegotiates the contract at a periodic interval that is predetermined or dynamically determined based on usage, application, user setting, software setting, hardware capabilities, etc.

Furthermore, as mentioned above, failsafe mechanisms may be placed to recover or disconnect in case of faults or errors. In one embodiment, a physical disconnect may cause the HV contract to discontinue immediately (e.g., source disconnects to 0 V). In one variant, the source and sink may fall back to a non-HV power contract. In one variant, the device may enter into a reset (e.g., hard reset, soft reset). In one variant, extant error recovery procedures may also be initiated, or error information and logs may be collected. In another embodiment, if any command, message, or request is timed out, i.e., not acknowledged by the receiving device, the HV contract may end, and any of the above mechanisms implemented.

Of further note, if any message, request, or command is corrupted, it will be detected in a CRC (cyclic redundancy check) calculation, and messaging will not proceed. The message may be resent in at least some cases or stages. In one embodiment, subsequent corruption will result in a hard reset or a fallback to non-HV or low-voltage contract steps. If wrong information is detected at any stage, HV validation may halt there as well, and the contract may stay limited to 100 W.

At least some of the foregoing operations may be performed serially or in parallel (simultaneously). As but one example, one message may be sent to the cable (e.g., “Get_Cable_Cap”) and one message sent to the sink (e.g., “Get_Sink_Cap_HV”) in one step.

At least some of the foregoing operations need not be performed in the order presented above. As but one example, “Get_Sink_Cap_HV” may occur prior to “Get_Cable_Cap”.

Furthermore, the messages, requests, and commands noted above are redundant so as to create a multi-point fail-stop. Generally, the more hardware or software conditions that must all fail together before an unsafe condition occurs, the better for device operation. Thus, multiple points of failure are included to give a device multiple “outs” and increase safety while providing higher voltages and wattages for improved power delivery and user experience.

Referring back to FIG. 6C, if the sink requests non-HV via, e.g., a “Request” (not “Request_HV”) request, the aforementioned non-HV voltages may be available for accepting by the source, at step 624.

Various actions taken by an HV-capable source, HV or non-HV sink, and HV or non-HV cable may be summarized as follows:

### HV Source, HV Cable, HV Sink

1. Connect
2. Source request Cable ID
3. Cable sends ID info
4. Source sends SRC Caps (≤100 W)
5. Sink sends Request
6. Source sends Accept
7. Source sets Voltage (≤20V)
8. Source sets Current Limit (≤100 W)
9. Source sends PS_Ready
10. Sink draws power (≤100 W)
11. Sink requests HV validation by sending a Get_Source_Cap_HV
12. Source requests Extended Sink Cap
13. Sink sends Extended Sink Cap
14. Source evaluates Ext. Sink Cap
15. Source requests Cable Cap
16. Cable sends Cable Cap
17. Source evaluates Cable Cap
18. Source requests HV Sink Cap
19. Sink sends HV Sink Cap
20. Source Evaluates HV Sink Cap
21. Source Sends HV Source Cap
22. Sink sends request for HV PDO
23. Source sends accept for HV PDO
24. Source sets Voltage (may be >20V)
25. Source sets Current Limit (may be >100 W)
26. Source sends PS_Ready
27. Sink draws power (may be >100 W)
28. Sink continuously repeats steps 22-27 at regular intervals

### HV Source, Non-HV Cable, HV Sink

1. Connect
2. Source request Cable ID
3. Cable sends ID info
4. Source sends SRC Caps (≤100 W)
5. Sink sends Request
6. Source sends Accept
7. Source sets Voltage (≤20V)
8. Source sets Current Limit (≤100 W)
9. Source sends PS_Ready
10. Sink draws power (≤100 W)
11. Sink requests HV validation by sending a Get_Source_Cap_HV
12. Source requests Extended Sink Cap
13. Sink sends Extended Sink Cap
14. Source evaluates Ext. Sink Cap
15. Source requests Cable Cap
16. Cable sends Cable Cap
17. Source evaluates Cable Cap
18. Cable Cap Fails
19. Source halts HV validation
20. Contract stays ≤100 W as set in steps 7 & 8

### HV Source, HV or Non-HV Cable, Non-HV Sink

1. Connect
2. Source request Cable ID
3. Cable sends ID info
4. Source sends SRC Caps (≤100 W)
5. Sink sends Request
6. Source sends Accept
7. Source sets Voltage (≤20V)
8. Source sets Current Limit (≤100 W)
9. Source sends PS_Ready
10. Sink draws power (≤100 W)
11. Sink does not proceed to HV validation request

### Exemplary HV Message/Encoding Types

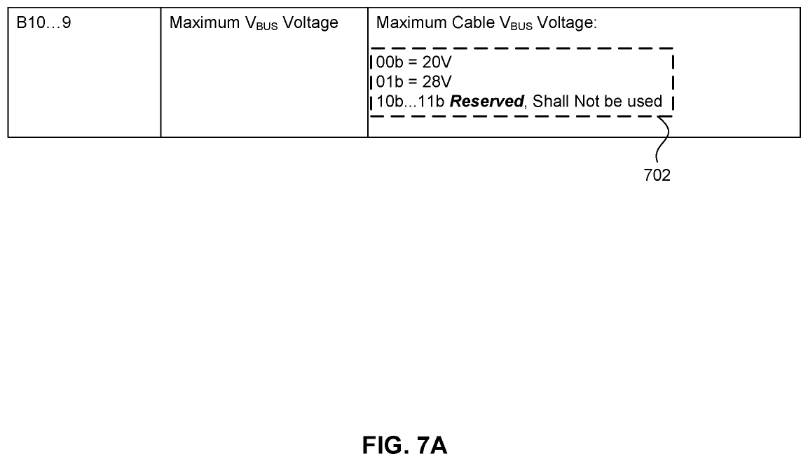

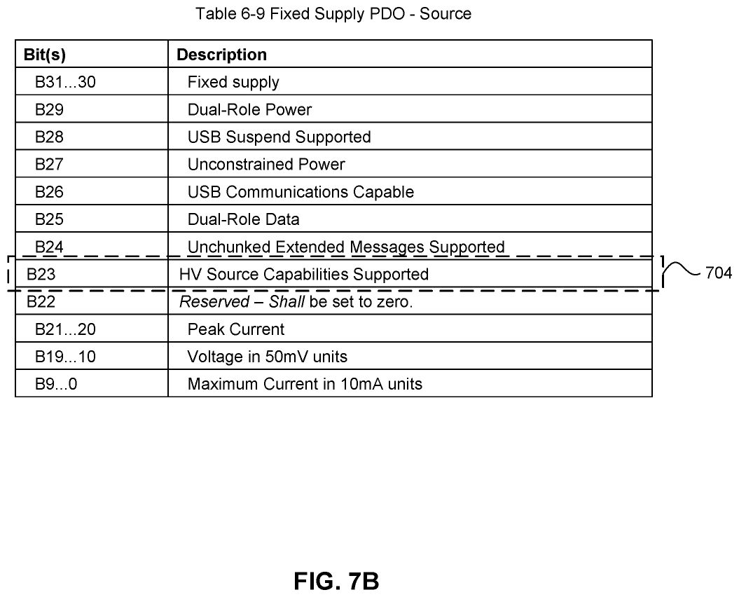

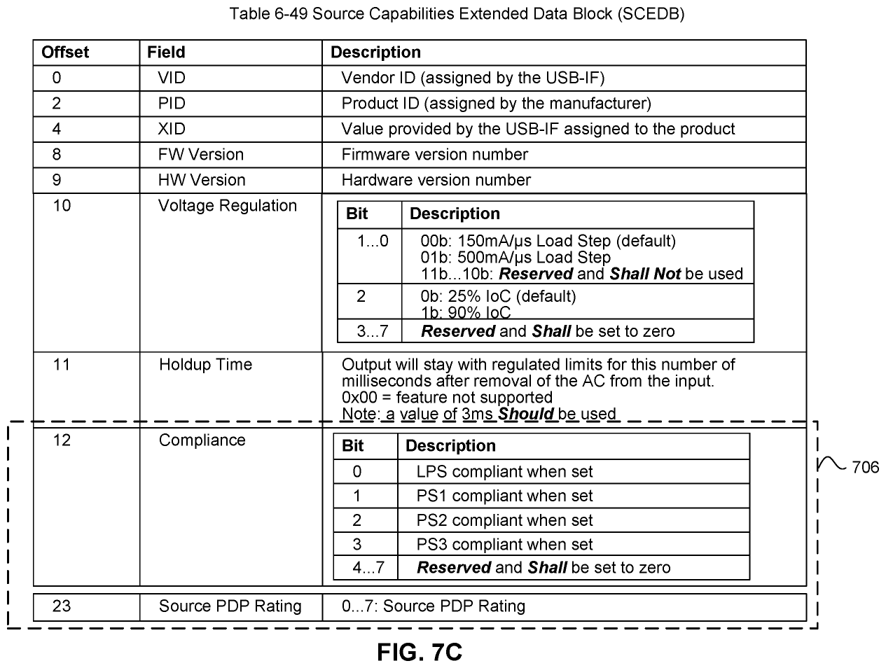

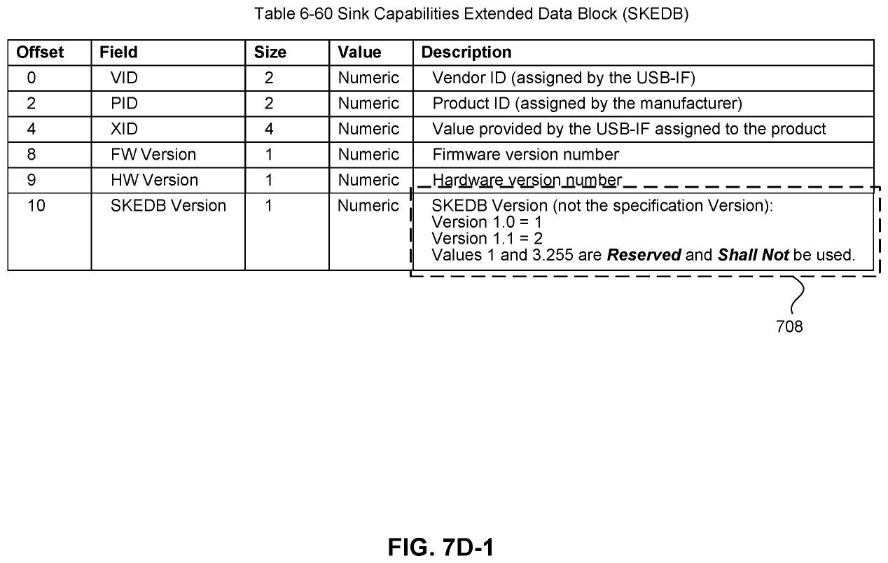

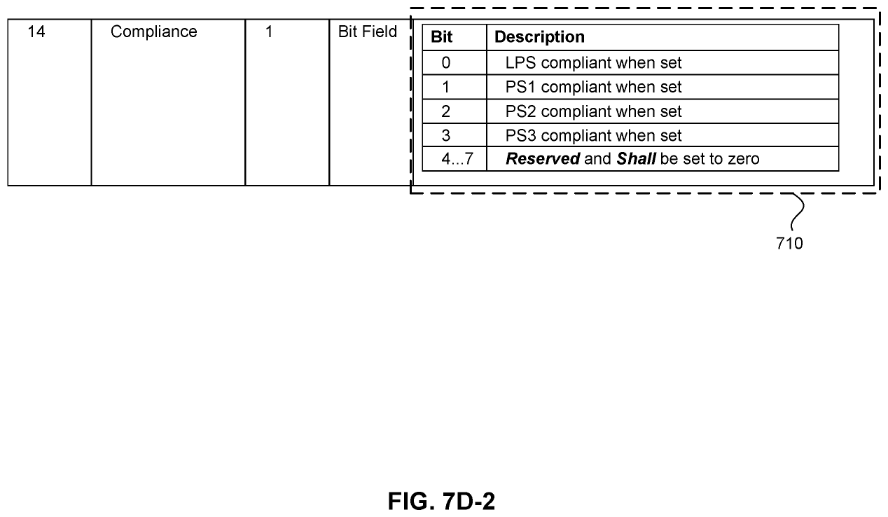

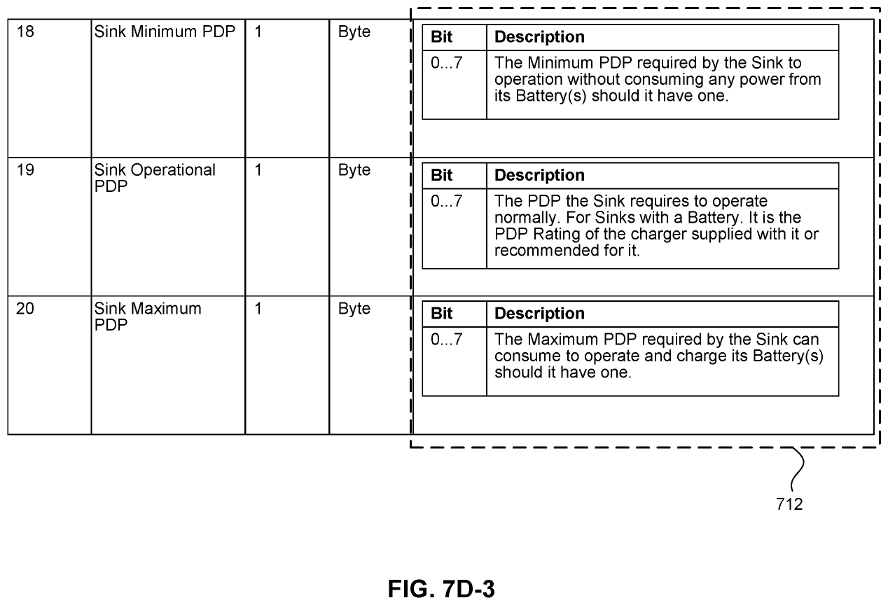

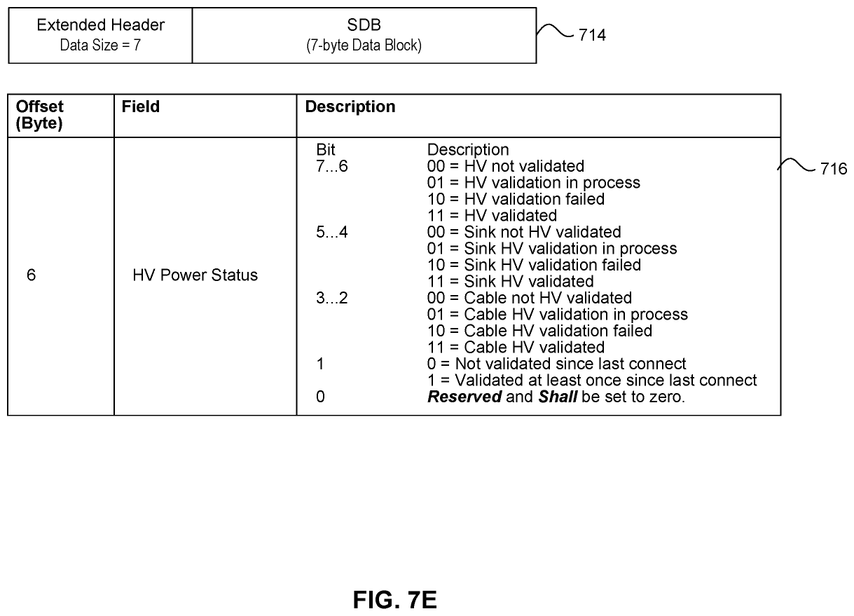

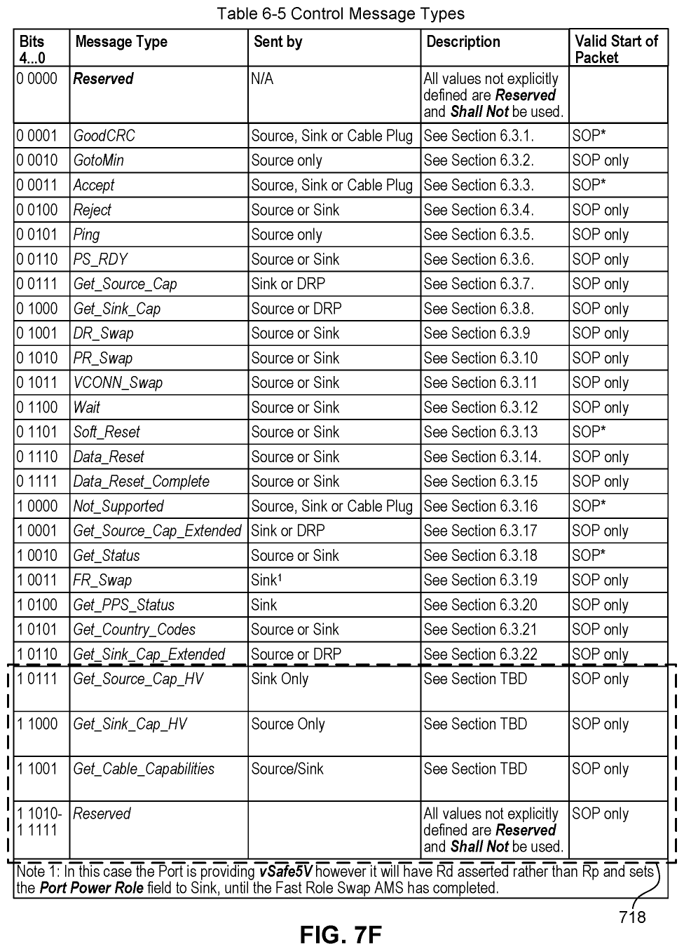

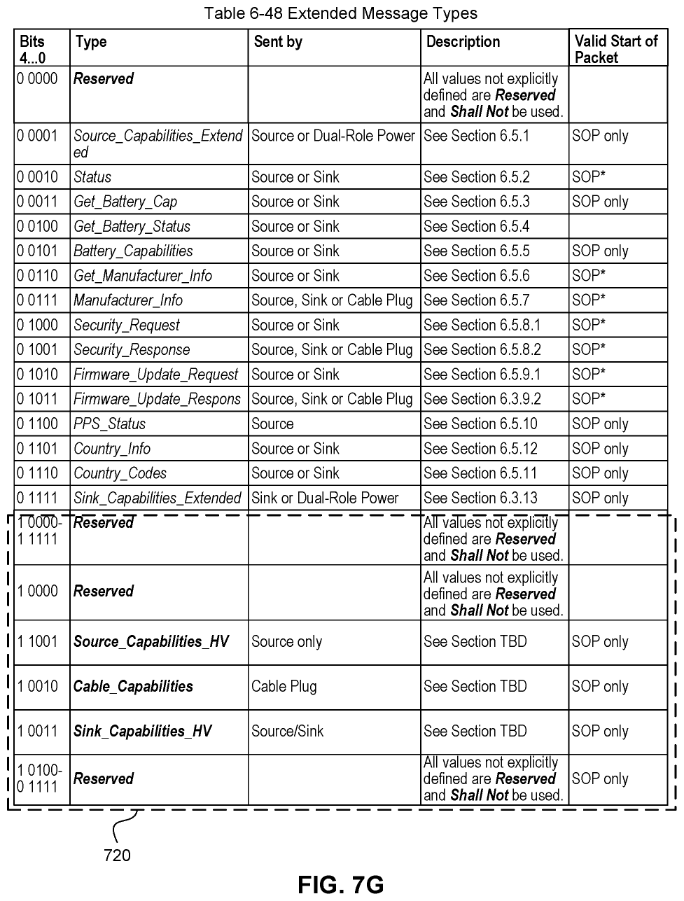

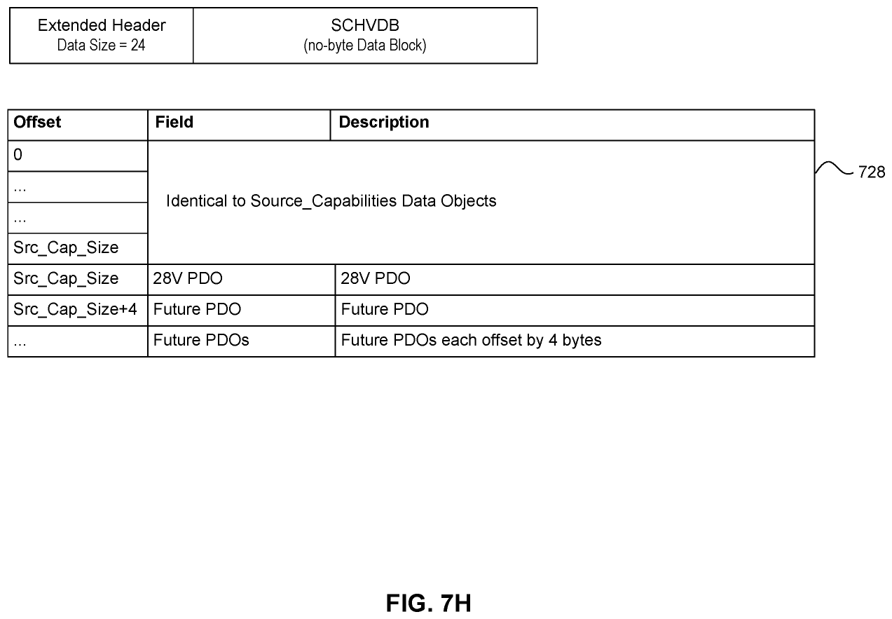

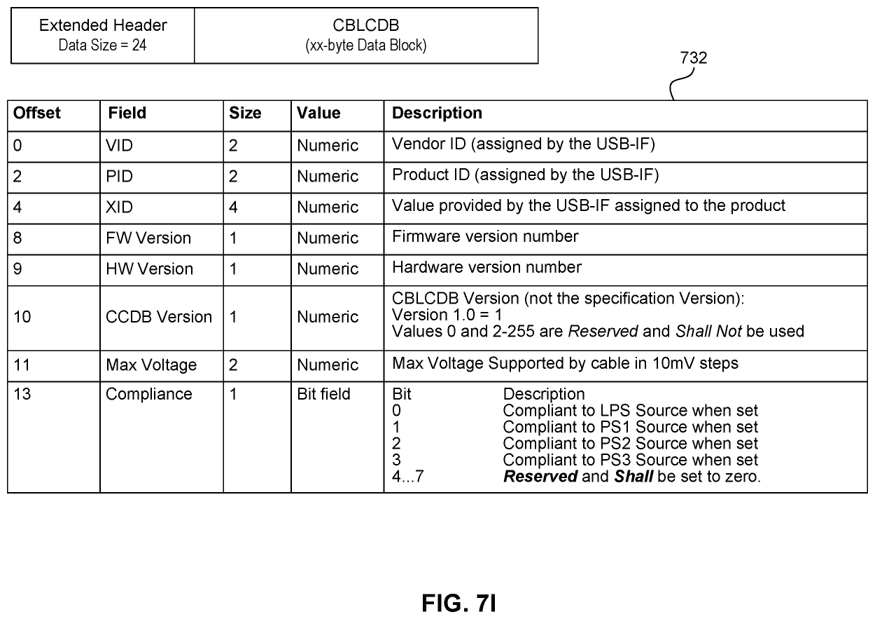

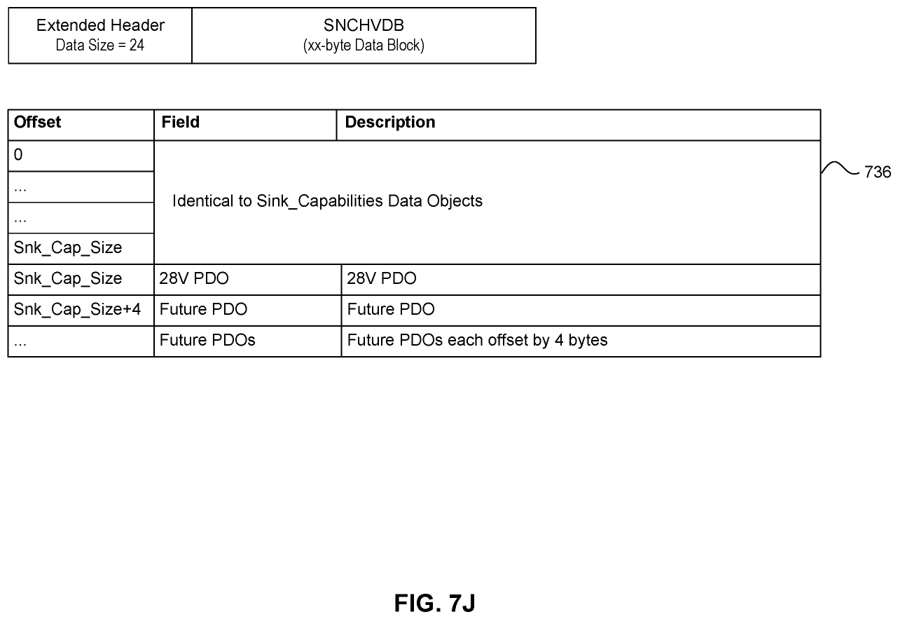

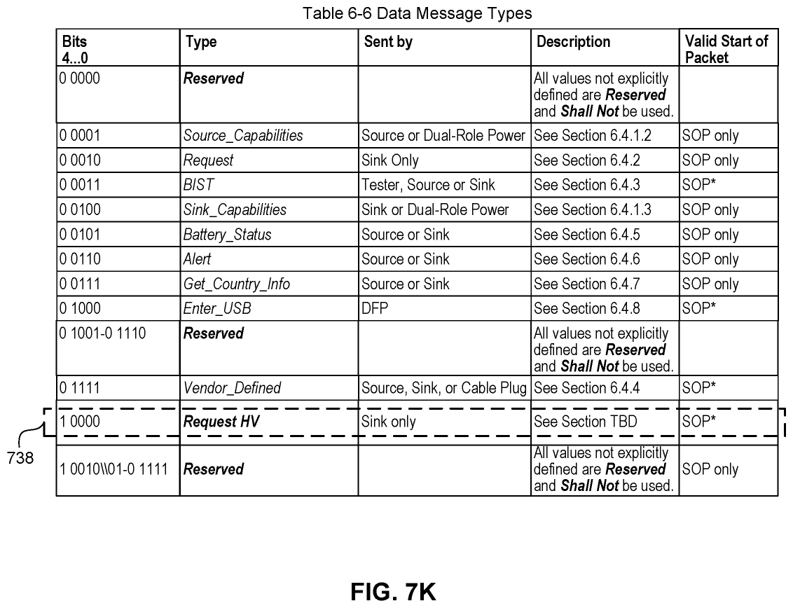

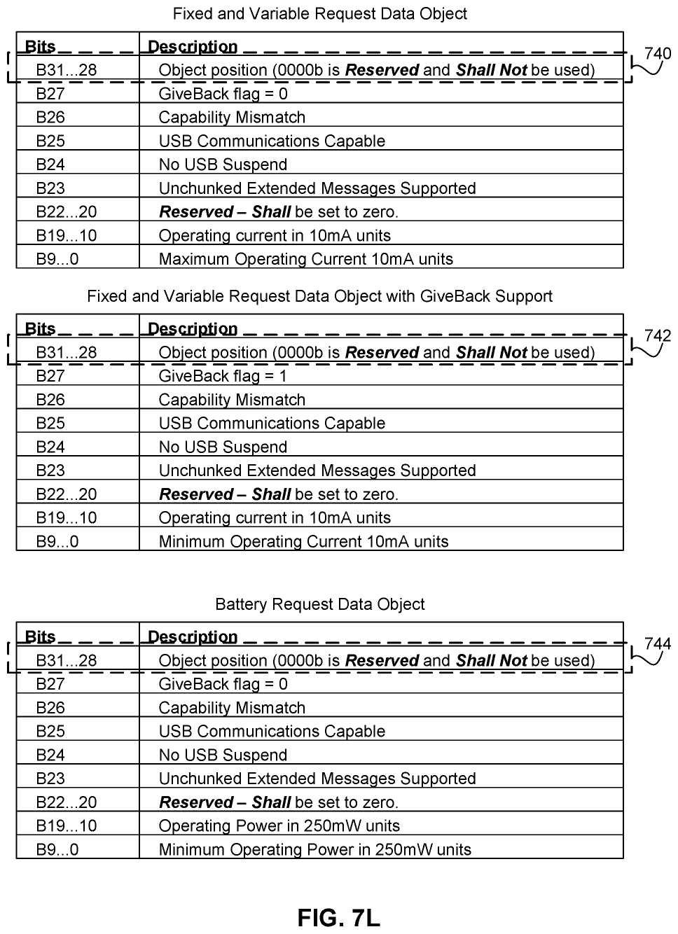

FIGS. 7A-7D-3, provide exemplary illustrations of various settings and encodings of data discussed above in the context of the USB-C standard.

For example, a maximum voltage value may be described by a bit (e.g., in a message sent or received by the source). By way of illustration, bit 00b of the max. cable voltage data field 702 may indicate 20 V on the V_{BUS}, and bit 01b may indicate 28 V (or another specified voltage). Other bits (10b, 11b, etc.) may be reserved for other used voltages or future voltages. See FIG. 7A.

Similarly, as shown in FIG. 7B, source capabilities may be described by the existence or the setting of a bit (e.g., to 1). For example, a setting in the B23 bit 704 may indicate that HV source capabilities are supported. On the other hand, a source that does not support voltages above 20 V (i.e., HV) may not set this bit, or set it to 0. If this bit is not set, the sink may not start the HV validation process according to the steps set forth above. See FIG. 7B.

As shown in FIG. 7C, extended source capabilities, including PS3 compliance and source power rating, may be described by one or more bits 706 as well. In one example, an additional bit (not used in non-HV operations) that indicates PS3 compliance may be set, along with other bits that indicate PS1 and/or PS2 compliance. Also, an additional bit to indicate the source rating of up to a certain wattage may be set. The setting of this bit may indicate 140 W (28V) operation is allowed. In one variant, the bit may be capable of indicating up to 256 W.

As shown in FIG. 7D-1, extended sink capabilities, including SKEDB version, PS3 compliance, minimum PDP (power delivery power), operational PDP, maximum PDP may be described one or more bits 708. In various embodiments, the SKEDB version must be higher than v1.0 (e.g., v1.1).

PS3 compliance may be indicated by an additional bit that is not used in non-HV communications. As discussed elsewhere herein, PS3 compliance allows the device to send and/or receive HV. In USB-C parlance, minimum PDP may indicate the wattage required by the sink to operate without consuming any power from its battery(s) should it have one. Operational PDP may indicate the wattage the sink requires to operate normally, for sink with a battery. It may also be associated with the PDP rating of the charger supplied with the sink or recommended for it. Maximum PDP may indicate the wattage the sink can consume to operate and charge its battery(s) should it have one. The minimum, operational, and maximum PDPs may each have an expanded bit number to indicate its respective parameter for HV operation. In one embodiment, each PDP bit may be set from seven different settings for typical non-HV operation (e.g., 0 through 6), but this range may be expanded to eight bit settings to accommodate HV operation (e.g., 0 through 7). Updated the PDPs to allow for higher wattage (e.g., over 100 W) indicates that such higher wattage can be achieved by the devices. See fields 710 and 712 in FIGS. 7D-2 and 7D-3, respectively.

In addition, a start-of-packet (SOP) status message 714 (e.g., at the start of a packet containing a power delivery message) may report the current status of HV validation process per data field 716. In the exemplary embodiment, the source may report the current status, and may be returned regardless of whether validation has been attempted, is in process, or has passed or failed. As compared to non-HV operation, the HV version of the SOP status message may in the exemplary embodiment have an increased size, e.g., to 7 bytes. See FIG. 7E.

As shown in FIGS. 7F and 7G and as discussed above, distinct control messages are sent or received in order to request or acknowledge HV operation, such as “Get_Sink_Capabilites_HV”, “Request_HV”, and “Get_Source_Cap_HV” to name a few. These are new control messages specific to the HV contracting process, although it will be recognized that in some variants, extant messages may be “repurposed” to convey at least portions of the necessary data. In exemplary embodiments, these new control messages may be similar to, and in fact otherwise identical to, existing control messages for non-HV operation, except that they allow, trigger, or otherwise indicate enhanced HV capabilities over or in addition to the specified parameters such as those defined in USB-C specifications.

As a brief aside, in the exemplary USB-C specifications, various bits represent corresponding message types, as shown in FIGS. 7F and 7G. Additional bit settings 718, 720 as disclosed herein advantageously allow HV-related messages to be exchanged. Applicable software (e.g., SKEDB version 1.1) may allow HV-specific messages to be recognized. Further examples of HV-specific control messages include “Get_Source_Cap_HV” (sent by the sink), “Get Sink_CAP_HV” (sent by the source), “Get_Source_Cap_HV”,“Get_HV_Validation_Status”, and “Get_Cable_Capabilities.”

It will also be appreciated that in other embodiments, the Get_HV_Validation_Status and/or HV_Validation_Status messages may be implemented as new additions of already existing Get_Status/Status messages.

To be more specific, in one exemplary embodiment, “Get_Source_Cap_HV” may be sent by the sink to the source to request HV capabilities of the source. The source may return “Not Supported” if HV is not supported or not validated. The source may return “Source_Capabilities_HV” if HV is validated.

In the exemplary embodiment, the control message “Get_Sink_Cap_HV” may be sent by the source to the sink to request HV capabilities of the sink. The sink may return “Not Supported” if HV is not supported or not validated. The source may return “Sink_Capabilities_HV” if HV is validated.

In one exemplary embodiment, the control message “Get_Source_Cap_HV” message may be sent by the sink to the source to request the source capabilities, and cause the source start the validation process for HV, subsequent to the initial non-HV contract. In another embodiment, a “Request_HV_Validation” message is sent. The source may return “Not Supported” if HV is not supported or not validated. The source may return an “ACK” if HV is supported. Additionally, in some embodiments, the source may enter a “Validation” state machine.

In the exemplary embodiment, the control message “Get_HV_Validation_Status” may be sent by the sink to the source to request a “HV_Validation_Status” message. In some variants, the requested “HV_Validation_Status” message may be called by another name, or other or additional status messages may be requested. The source may return “Not Supported” if HV is not supported or not validated. The source may return the requested “HV_Validation_Status” (or other requested message(s)) if HV is supported.

It will also be appreciated that in other embodiments, the Get_HV_Validation_Status and/or HV_Validation_Status messages may be implemented as new additions of already existing Get_Status/Status messages.

As shown in FIG. 7G, in the exemplary embodiment, the control message “Get_Cable_Capabilities” may be sent by the source (or sink) to the cable to request a “Cable_Capabilities” message. In some variants, the requested message may be denoted by another name, or other or additional messages may be requested from the cable. The cable may return “Not Supported” if “Cable_Capabilities” is not supported. The cable may return the requested “Cable_Capabilities” (or other requested message(s)) if supported. See FIG. 7G for examples of these returned messages (including specific fields relating to HV mode operation 720), otherwise referred to as “extended message types.”

In the context of the new control messages disclosed herein, these messages may be sent by either the source or sink, depending on which device is initiating or moderating the HV negotiation. For example, in different embodiments, “Get_Cable_Capabilities” may actually be sent by the source or the sink, depending on, or regardless, of which entity initiated the HV negotiation.

It is also noted that, according to different embodiments, either the source or the sink may initiate HV operation. The messages sent by a source (e.g., to offer HV capabilities) and acknowledged by sink in one protocol may be performed in the reverse direction where desired or beneficial. That is to say, the sink may be the device that offers HV capabilities, and checks that the source meets the requirements to establish the HV contract. Moreover, as referenced previously, combinations or permutations of the foregoing order may be used, such as where some functions are source-driven, and some are sink-driven, and some are “collaboratively” initiated.

As shown in FIGS. 7H-7I, to expand further on the aforementioned extended message types, and similar to the new control messages discussed above, these extended message types allow, trigger, or otherwise indicate greater power delivery output (also referred to as “PDO”) than the non-HV counterparts.

For example, as shown in FIG. 7H, in non-HV contracts, a “Source_Capabilities” message 728 may indicate that power delivery outputs of between 5 V and 20 V are possible. On the other hand, in one exemplary embodiment, a “Source_Capabilities_HV” message may indicate that power delivery outputs of between 5 V and 28 V are possible. In other embodiments, the extended message may indicate voltages above 28 V, as indicated in the appropriate messages and acknowledged by source, cable, and sink (if capable). This greater PDO range may be indicated by a data size field in the message header, as shown in FIG. 7I.

Further, a “Source_Capabilities_HV” message may additionally at least temporarily update any existing “Source_Capabilities” settings (such as the one indicated during non-HV contract negotiation) to update the capabilities of the source. In some scenarios, using the HV version of the message (i.e., “Source_Capabilities_HV”) may avoid the need to send two separate messages to update the capabilities, one of which may result in exiting the HV validation process.

As shown in FIG. 7I, “Cable_Capabilities” may have an extended message counterpart for HV, “Cable_Capabilities_HV” 732. Similar to “Source_Capabilities_HV”, the “Cable_Capabilities_HV” message may indicate PDOs of up to (or even beyond) 28 V.

As shown in FIG. 7J, in non-HV contracts, a “Sink_Capabilities” message 736 may indicate that power delivery outputs of between 5 V and 20 V are possible. In the exemplary embodiment, a “Sink_Capabilities_HV” message may indicate that power delivery outputs of between 5 V and 28 V are possible. In other embodiments, above 28 V may be possible. This greater PDO range may be indicated by a data size field in the message header, as shown in FIG. 7K.

As shown in FIG. 7K, the new data message type “Request_HV” 738 may be described by a bit in a data message to establish an HV power contract once validated via the multi-step validation process (see FIG. 3B). In one exemplary embodiment, the sink may transmit “Request_HV” to the source, once the source offers HV capabilities (via, e.g., “Source_Capabilities_HV” per above).

As shown in FIG. 7L, “Request_HV” is identical to the existing non-HV “Request” message type, except that certain one or more additional bits (e.g., B31) 740, 742, 744 may be used to describe, e.g., expanded PDO capabilities.

As part of the multiple safety features incorporated in the exemplary HV validation process described above, timers may be implemented to allow portions of the process to be timed-out. In one exemplary embodiment, a source HV validation timer (“SrcHVValidationTimer”) may be initiated. The source HV validation timer may indicate the maximum time a source has to complete the validation process. In some scenarios, it is desirable for the source to minimize the time spent on validation, and accordingly may be configured to minimize the time. The maximum time may be based on e.g., whether the time spent would starve the sink (of, e.g., power, data) for too long, and/or other criteria relating to the sink (or even the source). A source HV communications timer (“SrcHVCommsTimer”) may also be initiated in some configurations. The source may look for new PD (power delivery) traffic (e.g., requests, messages) from the sink to occur within this time while in a validated state. In the exemplary embodiment, the source HV communications timer is greater than the sink HV communications timer, as described below. If traffic is not received within this time, the source may initiate an error recovery procedure. This may provide, along with the sink HV communications timer, a backup to a typical disconnect detection so as to satisfy safety features or requirements, as it is desired to have no single-point failures (e.g., in case the sink HV communications timer fails to trigger).

A sink HV communications timer (“SnkHVCommsTimer”) may also be initiated. The sink may send new PD traffic as above to the source within this time while in a validated state. The sink HV communications timer may be set to be shorter than the source HV communications timer, as noted above. This may serve as another backup feature, along with the source HV communications timer, for the typical disconnect detection to effectuate the desired multiple-point failure mechanism.

### Exemplary HV Hardware Rules

In the inventive interface such as that of FIG. 1, the source 102, sink 104, and cable 106 must be capable of delivering and drawing power that is higher than specified for typical USB PD operation, i.e., HV operation greater than 20 V and 100 W. Accordingly, in exemplary embodiments, the hardware follows various rules when implementing HV validation and/or maintaining the HV contract.

In one configuration, an HV source does not offer HV PDOs (via, e.g., “Source_Capabilities_HV”) until the sink and cable are each validated as (i) supporting PS3, and (ii) supporting the specific HV voltages supported by the source. The HV source starts the HV validation process upon receipt of a “Get_Source_Caps_HV” from the sink, and in some embodiments, responds to the sink with a “Wait” signal. The HV source continues a validation that is in process, and responds with a Wait signal when a “Get_Source_Caps_HV” is received during the validation process. In the exemplary configuration, an “ErrorRecovery” always causes a disconnect, and causes the process to start over. Hence, the result is a transition to 0V, and starting at the beginning of the process control loop again.

In some embodiments, the HV source responds with “Not Supported” to a “Get_Source_Caps_HV” if validation has failed. Conversely, the HV source sends “Source_Capabilities_HV” upon the successful completion of the validation process. A voltage greater than 20 V will not be sent in a non-HV “Source_Capabilities” message and is only sent in response to “Source_Capabilities_HV”. The HV source is HV validated upon receipt of a valid CRC (“goodCRC”) to a “Source_Capabilities_HV” message. The HV source initiates error recovery upon receipt of a “Request_HV” when not validated in some embodiments as well.

To exit the validated state, and to maintain the connection, an HV Source sends a “Source_Capabilities” message. The HV source exits the validated state upon receipt of a goodCRC to a “Source_Capabilities” message. The HV source maintains the HV contract until receipt of the goodCRC of an ACK as response to a Request signal following a “Source_Capabilities” message, and transitions to the new non-HV contract as normal. The HV source may initiate error recovery upon receipt of a Request when in the validated state (where no “Source_Capabilities” has been sent to exit validated state). The HV source may also initiate error recovery if it does not receive periodic PD (power delivery) traffic from the sink within the “SrcHVCommsTimer” time while in the validated state. A satisfactory CRC result (goodCRC) to a source-initiated message is sufficient to satisfy this condition in the exemplary embodiment. The HV source supports the full range of power up to 100 W on 5, 9, 15 and 20 V following extant USB PD power rules.

In some configurations, an HV sink does not send a “Request_HV” unless it has received a “Source_Capabilities_HV” (not “Source_Capabilities”) as the last offering. The HV sink may also send periodic PD traffic with “SnkHVCommsTimer” time while operating in the validated state (i.e., the HV sink has received a “Source_Capabilities_HV” as last offering). This may be any PD message or a goodCRC response to a message. Note that a “Ping” is also available to send to satisfy this requirement when there is no other traffic.

The HV sink sends a “Request_HV” to negotiate any contract if the last capabilities from the source was a “Source_Capabilities_HV”. The HV sink sends a Request signal to negotiate a contract if the last capabilities from the Source was a “Source_Capabilities”. The HV sink may send Request to enter a ≤20V contract; in this case, the source invalidates any HV negotiation. To exit the validated state and maintain the connection, an HV sink sends a “Get_Source_Caps” to initiate a “Source_Capabilities” from the source. The HV sink does not send a “Get_Source_Caps_HV” if a CTVPD (Charge-Through V_{CONN}-Powered USB Device) is attached between the source and the sink. The HV sink initiates error recovery if it receives a “Source_Capabilities_HV” while a CTVPD is attached between the source and the sink.

In the exemplary system of FIG. 1., an HV cable which supports 5 A current operation is utilized, although those with other (e.g., higher) capacities may be utilized. The exemplary HV cable reports in a Discover ID response its capability (e.g., that it is 5 A capable), and reports the HV voltage supported. The exemplary HV cable is compliant to PS3 sources, and reports in a “Capable_Capabilities” message that it is PS3 compliant, and the HV voltage which it supports.

Note that extant “Source_Capabilities” and “Sink_Capabilities” messages do not contain PDOs with voltage greater than 20 V nominal. The structure of PDOs and HV PDOs are the same. Put another way, the inventive “Source_Capabilties_HV” messages are an extension of the “Source_Capabilties” messages, and accordingly in certain embodiments should contain the same PDO voltages in the same (existing) order, with the new HV PDOs added at the end (e.g., via successive bits). For example, 28 V and/or others may be indicated along with 5, 9, 15 and 20 V. Likewise, other (e.g., higher) or multiple “stepped” values may be appended as well.

Additionally, HV operation requires an extension to the normal power rules relating the power delivery rating (W), voltage (V), and the current (A) that a cable may provide.

TABLE 2

| PDP | Current | Current | Current | Current | Current |
|---|---|---|---|---|---|
| Rating | at 5 V | at 9 V | at 15 V | at 20 V | at 28 V |
| (W) | (A) | (A) | (A) | (A) | (A) |
| 0.5 ≤ x ≤ 15 | x ÷ 53 | | | | |
| 15 < x ≤ 27 | 3 | x ÷ 9 | | | |
| 27 < x ≤ 45 | 3 | 3 | x ÷ 15 | | |
| 45 < x ≤ 60 | 3 | 3 | 3 | x ÷ 20 | |
| 60 < x ≤ 100 | 3 | 3 | 3 | x ÷ 20¹ | |
| 100 < x ≤ 140 | 3 | 3 | 3 | 5¹ | x ÷ 28 |

¹Requires 5A cable.

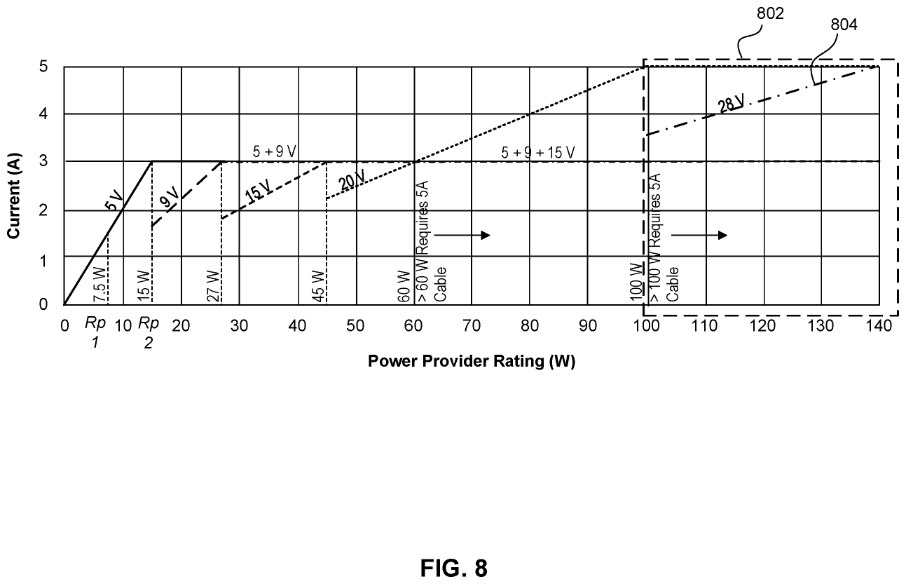

As can be seen in FIG. 8, in conjunction with Table 2 above (illustrating exemplary relationships among power delivery power (PDP) rating, voltage, and maximum current, including at exemplary PDP rating of 28 V), the greater the power provider rating (wattage) and the greater the voltage (indicated by different lines of FIG. 8), the greater the current. However, current may be limited to a certain level (e.g., 3 A, 5 A) depending on e.g., cable capability.

As an example, delivery of 45 W of power over a 3 A-capable cable will require 15 V to drive the power. To deliver between 45 and 60 W over the 3 A cable, it will require more than 15 V (e.g., 20 V). However, to go beyond that, a 5 A cable may be necessary, along with greater voltage, to deliver greater power. At 20 V, a 5 A cable can reach 100 W, as specified in USB PD.

By implementing a HV contract according to the present disclosure (i.e., assuming various safety checks have been cleared with the source, sink, and cable), 28 V (see line 804 of FIG. 8) may be applied to a 5 A cable to deliver greater than 100 W within the illustrated operating region 802.

FIG. 9 illustrates a graph of component operating voltage versus various USB-PD “contract” wattage/voltage combinations.

As a brief aside, to increase maximum power (wattage), voltage and/or current must be increased (P=I×V). Increasing current is limited by at least two factors: connector rating and so-called I²R loss. The latter wire loss or resistive power loss is due to high currents, which may introduce other issues such as heat dissipation by the conductors, which may cause the device and its components (e.g., batteries) to overheat and potentially cause unsafe operation conditions. In contrast, increasing voltage is only limited by component availability and capacity (e.g., ratings). Thus, voltage modification is the preferred method for scaling power in exemplary embodiments of the USB-C interfaces and supporting circuitry described herein, although by no means an exclusive requirement.

As discussed supra, USB PD presently calls for a maximum voltage of 20 volts. This voltage may be scaled for higher power. In exemplary embodiments described herein, device components may be configured to operate at a maximum of 28 V, resulting in a nominal wattage of 140 W ash sown by the operating point 902 on FIG. 9. Absolute maximum ratings and de-rating practices and recommendations associated with commonly available components are advantageously compatible with such 28V operation.

For instance, in the FET (field effect transistor) industry, the recommended voltage de-rating is 75%. This means that a 40V-rated component will operate at 30 V.

As another example, in the polymer tantalum capacitor industry, the recommended voltage de-rating is 80%. A 35V-rated component will hence operate at 28 V, providing a potential maximum of 140 W.

As an aside, polymer tantalum capacitors whose standard voltage ratings are 35 V and 50 V may be useful for electronic noise mitigation. However, low-power devices (e.g., mobile user devices) may not fit polymer tantalum capacitors but instead may use ceramic capacitors for inputs where operating voltage limits may be higher (e.g., 25-50 V).

It will also be appreciated that charger/controller silicon IP capability is highly vendor dependent, and hence design margin reductions vs. component rating may be considered as part of the design configuration when choosing an appropriate voltage range for a given application.

As such, FIG. 9 illustrates some of the various types of foregoing components and considerations, and their relationship to voltage and power delivery for exemplary different types of devices and applications (e.g., automotive, USB-PD mobile devices, etc.). It will be appreciated by those of ordinary skill that depending on the selected application, the methods, apparatus, and particular parameters for a given power interface (such as the maximum HV voltage) can be optimized in order to provide both performance, cost efficiency, and meet all relevant safety considerations and requirements.

### Additional Considerations

As noted elsewhere herein, at least portion of the initiation and management of validating and negotiating for HV (or non-HV) power delivery or power draw may be performed by the sink device as opposed to the source, as described with respect to the exemplary methodologies. As such, control or other messages or requests that are transmitted by one device may be adapted for transmission by the other device instead, consistent with existing protocol requirements.

While the computer-readable medium described previously herein is deemed in an example embodiment to be a single medium, the term “computer-readable medium” should be taken to include a single medium or multiple media (e.g., a centralized or distributed database, or associated caches and servers) able to store the instructions. The term “computer-readable medium” should also be taken to include any medium that is capable of storing instructions for execution by any computing system which cause the computing system or any of its components or devices in data communication therewith (e.g., peripherals) to perform, for example, one or more of the methodologies disclosed herein or portions thereof.

It will be recognized that while certain aspects or embodiments of the present disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various embodiments, it will be understood that various omissions, substitutions, and changes in the form and details of the devices or processes illustrated may be made by those skilled in the art without departing from the principles described herein. This description is in no way meant to be limiting, but rather should be taken as illustrative of the general principles of the disclosure. The scope of the disclosure should be determined with reference to the claims.

It will be further appreciated that the disclosed aspects and individual methods and apparatus are generally computerized or computer-implemented. Computerized apparatus and methods are necessary to fully implement these aspects for any number of reasons including, without limitation, commercial viability, practicality, and even feasibility (i.e., certain steps or processes simply cannot be performed by a human being in any viable fashion).

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A method for a source device to provide high voltage (HV) electrical power delivery to a sink device, comprising:
transmitting a non-HV power contract to the sink device that includes information relating to power and delivery;
receiving an acknowledgement from the sink device accepting the non-HV power contract;
transmitting a sink capabilities request to the sink device;
receiving sink HV capabilities in response to the transmitted sink capabilities request; and
initiating HV power transfer based on the received sink HV capabilities.

2. The method of claim 1, further comprising:
transmitting a cable capabilities request to an electrical cable connecting the source device to the sink device; and
receiving, from the electrical cable, HV transmission capabilities.

3. The method of claim 2, wherein the initiating includes confirming that the electrical cable is capable of driving a minimum specified current, and has a maximum voltage rating that will support HV power transmission.

4. The method of claim 2, wherein the initiating includes establishing an HV power contract with the sink device.

5. The method of claim 4, wherein the initiating includes enabling a heartbeat signal across the electrical cable that is periodically received from the sink device to maintain the HV power contract.

6. The method of claim 5, further comprising:
determining that the heartbeat signal was not received as expected; and
reverting to the non-HV power contract in response to the determining.

7. The method of claim 4, further comprising:
establishing a timer;
determining that the timer has expired prior to an expected event occurring; and
reverting to the non-HV power contract in response to the determining.

8. A method for managing enhanced Universal Serial Bus type C (USB-C) power transfer by a source device, comprising:
establishing a first power transfer agreement with a sink device;
determining that the sink device is capable of high voltage (HV) power exchange;
establishing a second power transfer agreement with the sink device in response to the determining;
monitoring, during execution of the second power transfer agreement, at least one condition; and
reverting from the second power transfer agreement to the first power transfer agreement based on the monitoring.

9. The method of claim 8, wherein the first power transfer agreement is a non-HV power transfer agreement.

10. The method of claim 9, wherein the second power transfer agreement is an HV power transfer agreement.

11. The method of claim 8, wherein the determining includes:
transmitting a capabilities request to the sink device; and
receiving a response message from the sink device that includes HV capabilities of the device.

12. The method of claim 8, wherein the at least one condition includes at least one condition of the electrical cable, at least one condition of the sink device, and at least one condition of the source device.

13. The method of claim 8, wherein the at least one condition includes periodically receiving a heartbeat signal.

14. A device for high voltage (HV) Universal Serial Bus power transfer to a sink device, the device comprising:
a power source;
a power transfer interface; and
one or more processors configured to:
transmit a non-HV power contract to a sink device that includes information relating to power and delivery;
receive an acknowledgement from the sink device accepting the power contract;
transmit a sink capabilities request to the sink device;
receive sink HV capabilities in response to the transmitted sink capabilities request; and
initiate HV power transfer from the power source based on the received sink HV capabilities.

15. The device of claim 14, wherein the one or more processors are further configured to:
transmit a cable capabilities request to an electrical cable connecting the source device to the sink device; and
receive, from the electrical cable, HV transmission capabilities.

16. The device of claim 15, wherein the initiating includes confirming that the electrical cable is capable of driving a minimum specified current, and has a maximum voltage rating that will support HV power transmission.

17. The device of claim 14, wherein the initiating includes establishing an HV power contract with the sink device.

18. The device of claim 17, wherein the initiating includes enabling a heartbeat signal across the electrical cable that is periodically received from the sink device to maintain the HV power contract.

19. The device of claim 18, wherein the one or more processors are further configured to:
determine that the heartbeat signal was not received as expected; and
revert to the non-HV power contract in response to the determining.

20. The device of claim 17, wherein the one or more processors are further configured to:
establish a timer;
determine that the time has expired prior to an expected event occurring; and
revert to the non-HV power contract is response to the determination.
